(19) United States
(12) Patent Application Publication
(10) Pub. No.: US 2016/0342678 A1
(43) Pub. Date: Nov. 24, 2016

(54) MANIPULATION OF ARBITRARILY RELATED DATA

(71) Applicants: Ronald Louis Newman, Santa Fe, NM (US); Pradip Hari, Austin, TX (US)

(72) Inventors: Ronald Louis Newman, Santa Fe, NM (US); Pradip Hari, Austin, TX (US)

(21) Appl. No.: 14/718,863

(22) Filed: May 21, 2015

(51) Int. Cl. G06F 17/30; G06K 9/20; G06F 3/0484

(52) U.S. Cl. CPC G06F 17/30598; G06F 17/30958; G06F 17/30061; G06F 3/0484; G06K 9/2054

(57) ABSTRACT

The present invention teaches methods for applying network graphing to visualization of all types of data and to human collaborative interaction. This method overcomes several limitations of prior art by allowing interactive manipulation and editing of large graphs in their entirety, by allowing rich content including video and text, by allowing real-time collaboration by a plurality of users, and by including Undo/Redo functionality. The entirety of the disclosure may be applied to hierarchically-structured graphs and data, non-hierarchically-structured graphs and data, free-form graphs and data, or any combination thereof. In addition, the present invention teaches methods for numerous user interface enhancements for editing, viewing and manipulation of graphical depictions of data.

### CROSS REFERENCE TO RELATED APPLICATIONS

(none)

### STATEMENT REGARDING FEDERALLY SPONSORED R&D

(none)

### NAMES OF PARTIES TO A JOINT RESEARCH AGREEMENT

(none)

### STATEMENT REGARDING PRIOR DISCLOSURES

(none)

### FIELD OF THE INVENTION

The present invention pertains to data visualization, especially where the relationships between data is important. The present invention further relates to representations of large data sets with complex interrelationships which are enabled for real-time collaborative, interactive viewing and editing of data, including but not limited to knowledge discovery and knowledge management.

### BACKGROUND OF THE INVENTION

Mind Mapping and Concept Mapping software applications are intended to facilitate brainstorming and mental organization by enabling the manual creation of diagrams that depict ideas and the relationships between them.

Mind Maps are common due to the limited, well-defined and easy to represent nature of hierarchal data relationships which are common in books (for example, a table of contents), Software applications, websites and other media. However, such maps present limitations when representing data containing more complex, non-hierarchal or circular relationships. In addition, accessing Mind Map data can be challenging when a user is forced to navigate many generations of parent-child relationships before the desired information is reached.

Concept Maps allow for greater flexibility in representing data, typically allowing for connections of any type between any data objects, including cross links, multiple connections, directional relationships, and circular relationships. The flexibility allowed in Concept Maps allows representation of complex data relationships, however, in the prior art this flexibility nevertheless retains compromises in effective data representation or interactive data editing.

Drawbacks in prior art Mapping Software include: inconvenient and inflexible user interfaces, lack of real-time collaborative editing capabilities, and inability to display very large Maps or effectively utilize resource-constrained devices. The present invention remedies these deficiencies with the additional benefit of facilitating the application of Concept Mapping to a broader set of data analysis, visualization, and manipulation tasks by providing rich content in the form of embedded video and links to external web sites as well as the ability to construct and manipulate Maps under programmatic control.

The collaborative capability of Mapping Software has lagged behind its development in single-user contexts. Typical issues include the handling of user permissions and conflict resolution, of maintaining “state” so that Undo/Redo become possible, of representation of map objects in a way that is translatable by remote computers, and other challenges.

U.S. Pat. No. 5,506,937 describes a computer system having an explanation facility for facilitating user understanding of concepts underlying a domain of knowledge which enables a user to interact with and explore the domain of knowledge. The explanation facility utilizes a concept-map based representation of a domain of knowledge and several icons to control the mode of output of information from the computer system. Each concept map has concept nodes which represent concepts in the domain of knowledge, links between the concept nodes, and icons. The icons are positioned at the concept nodes and represent alternative modes of output of information from the computer system. A user desiring more information about a concept node can select one of the icons corresponding to the mode of output of information desired. Modes of output of information include audio, video (images and movies), text, concept maps, and combinations of the foregoing. Through the use of concept maps and icons that control modes of output of information, a user may navigate the domain of knowledge and retrieve information specific to the user's particular needs.

This system presents a baseline of computer-based concept mapping but does not provide multi-user real-time remote collaboration, does not integrate with or link to internet data and does not include the improved user interface features described in the present invention.

U.S. Pat. No. 7,203,910 describes a method and apparatus for organizing and processing pieces of interrelated information (or “thoughts”) using a digital computer is disclosed. The invention employs a graphical user interface to facilitate user interaction with highly flexible, associative “matrices” that enable users conveniently to organize digitally-stored thoughts and their network of interrelationships. Each of the thoughts may be affiliated with one or more application programs, such as a word processing or spreadsheet utility, or an Internet browser. Users are able conveniently to select a current thought along with any applications or content associated with that thought by interacting with the graphical representation. That representation is automatically reoriented about the selected thought, and is revised to reflect only those thoughts having predetermined relations to that current thought. Users can easily modify the matrix by interactively redefining relations between thoughts. Further aspects of the invention include techniques permitting automated generation of thought matrices, delayed loading to facilitate navigation amongst thoughts without undue delay due to bandwidth constraints, and matrix division and linking to allow optimal data structure flexibility. The present invention is interoperable with computer networks including the Internet, and offers an intuitive scalable methodology for the navigation and management of essentially immeasurable information resources and knowledge bases that transcends the limitations inherent in traditional hierarchical approaches. Thought matrices may conveniently be published and shared by multiple users under another aspect of the present invention. Still another aspect enhances communications amongst computer network users by sharing information about users' navigation amongst shared thoughts. The present invention offers advantages over prior art methods when speech is used to control a computer. Lastly, another aspect of the present invention provides users of a computer network automatically to receive custom content in response to their navigation of network files, without modifying those files.

This method and apparatus is severely limited in that multi-user remote collaboration is not available in real time but requires synchronization. Additionally, it can only display small subsets of large maps, a few nodes at a time.

U.S. Patent Application 20050188333 describes a method for navigating a pointer on a graphical user interface (GUI) includes the steps of: scrolling an input device to locate the pointer corresponding to the input device on a point of interest within the GUI, depressing an actuating button associated with the input device on the point of interest, obtaining a detailed view of the point of interest while centering the point of interest on the GUI and maintaining a position of the pointer on the point of interest.

This describes a method of navigating a graphical user interface (GUI) pointer which lacks the ability of animated movement to a second point of interest of the GUI view itself as opposed to animating the pointer only, and also lacks the ability to deal with two or more points of interest which are all away from the center of the GUI.

### SUMMARY OF THE INVENTION

The present invention is an apparatus for visualizing and manipulating sets of inter-related data, typically represented as visual nodes in a graphical Map, with relationships between nodes optionally indicated by Edges. The present invention describes a system for storing nodes, removing nodes, organizing nodes, and modifying nodes, and optionally storing Edges, removing Edges, organizing Edges, and modifying Edges. Also included are improvements to the prior art which allow one or more Maps to be presented to an individual user or speedily to multiple physically separated users while also allowing larger Maps to be presented in their entirety; overcoming limitations in the execution speed and storage limitations of the devices used to display the Maps.

The present invention is a method for visualizing and manipulating sets of inter-related data, typically represented as visual nodes in a graphical Map, with relationships between nodes optionally indicated by Edges. The present invention describes a method for storing nodes, removing nodes, organizing nodes, and modifying nodes, and optionally storing Edges, removing Edges, organizing Edges, and modifying Edges. Also included are improvements to the prior art which allow one or more Maps to be presented to an individual user or speedily to multiple physically separated users while also allowing larger Maps to be presented in their entirety; overcoming limitations in the execution speed and storage limitations of the devices used to display the Maps.

It is therefore a primary object of the present invention to provide manipulatable visualizations of sets of inter-related data with improved updates of said manipulations for local or remote users.

It is a further object of the present invention to provide manipulatable visualizations of sets of inter-related data with improved scalability to large datasets.

It is still a further object of the present invention to provide manipulatable visualizations of sets of inter-related data with improved manipulation of relationships between individual dataset items.

It is still a further object of the present invention to provide manipulatable visualizations of sets of inter-related data with greater ease of interaction and navigation with said visualization.

These and other objects of the present invention will become apparent to those skilled this art upon reading the accompanying description, drawings, and claims set forth herein. The headings provided herein are for the convenience of the reader only. No headings should be construed to be limiting upon the content in any way.

### BRIEF DESCRIPTION OF THE DRAWINGS

FIG. 1 illustrates the system components in one preferred embodiment of the present invention.

FIG. 2 depicts the Map Client architecture in one preferred embodiment of the present invention.

FIG. 3 depicts the Map Server architecture in one preferred embodiment of the present invention.

FIG. 4 depicts detail of the change request handling module in one preferred embodiment of the present invention.

FIG. 5 depicts a continuation of the Map Server architecture in one preferred embodiment of the present invention.

FIG. 6 illustrates the process by which listening Map Clients are made known to a server.

FIG. 7 depicts the sharing manager of the present invention.

FIG. 8 illustrates the local map model of the present invention.

FIG. 9 depicts the Entity Locator construction algorithm of the present invention.

FIG. 10 depicts the Entity Locator query algorithm of the present invention.

FIG. 11 depicts the Entity Locator insertion algorithm of the present invention.

FIG. 12 depicts the Entity Locator deletion algorithm of the present invention.

FIG. 13 illustrates Map Entity creation in the present invention.

FIG. 14 illustrates Map Entity modification in the present invention.

FIG. 15 illustrates Map Entity deletion in the present invention.

FIG. 16 illustrates the rendering engine of the present invention.

FIG. 17 illustrates the rendering algorithm of the present invention.

FIG. 18 illustrates rendering with pan and zoom support in the present invention.

FIG. 19 illustrates Map simplification on zoom out in the present invention.

FIG. 20 further illustrates Map simplification on zoom out in the present invention.

FIG. 21 illustrates typical Map Entities in the present invention.

FIG. 22 illustrates Map simplification in the present invention.

FIG. 23 illustrates embedding a map in the present invention.

FIG. 24 illustrates Node maximization in the present invention.

FIG. 25 further illustrates Node maximization in the present invention.

FIG. 26 illustrates Coronas in the present invention.

FIG. 27 further illustrates Coronas in the present invention.

FIG. 28 yet further illustrates Coronas in the present invention.

FIG. 29 yet further illustrates Coronas in the present invention.

FIG. 30 illustrates the Edge navigation feature of the present invention.

FIG. 31 further illustrates the Edge navigation feature of the present invention.

FIG. 32 yet further illustrates the Edge navigation feature of the present invention.

FIG. 33 depicts the Edge label fitting feature of the present invention.

FIG. 34 further depicts the Edge label fitting feature of the present invention.

FIG. 35 yet further depicts the Edge label fitting feature of the present invention.

FIG. 36 depicts Edge repositioning in the present invention.

FIG. 37 further depicts Edge repositioning in the present invention.

FIG. 38 depicts additional steps in Edge repositioning in the present invention.

FIG. 39 depicts further additional steps in Edge repositioning in the present invention.

FIG. 40 illustrates clustering in the present invention.

FIG. 41 further illustrates clustering in the present invention.

FIG. 42 yet further illustrates clustering in the present invention.

FIG. 43 yet further illustrates clustering in the present invention.

FIG. 44 illustrates undo and redo features of the present invention.

FIG. 45 further illustrates undo and redo features of the present invention.

FIG. 46 yet further illustrates undo and redo features of the present invention.

FIG. 47 yet further illustrates undo and redo features of the present invention.

FIG. 48 illustrates additional steps in undo and redo features of the present invention.

FIG. 49 further illustrates additional steps in undo and redo features of the present invention.

FIG. 50 illustrates the differentiation of recently-changed Map Entities in the present invention.

### DETAILED DESCRIPTION OF THE INVENTION

### 1. Definitions

“Mind Map” as used herein describes a visualization of hierarchical data, for example, a graphical display of data optimized to display parent-child relationships.

An “Edge” as defined herein refers to a relationship between data objects. Edges may contain additional media Entities which describe or represent the relationship between the associated connected Nodes. In addition, Edges may be directional, further specifying attributes of the relationship between the associated connected data objects.

“Nodes” as used herein refer to data objects represented on Mind Maps or Concept Maps. Nodes may have zero or more connected Edges.

“Concept Map” as used herein, refers to a visualization of multiply connected, non-hierarchical data and/or unconnected data Concept maps can be thought of as generalization of mind maps, the latter being a subset of the former.

“Entity” or “Map Entity” as used herein refers to any element or representation of data contained within or associated with a Map. Edges, Nodes, and Clusters are examples of Entities. Any other element or representation of data contained within or associated with a Map is by definition an Entity without departing from the scope of the present invention.

“Content” as used herein refers to content that is presented within the visual boundaries of a Map Entity, visually attached to a Map Entity, associated with a Map Entity through hypertext or hypermedia link, or otherwise associated with a Map Entity, where “Entity” refers to any component part, visible or non-visible, of a Map, for example but not limited to a Node, Edge, Tunnel, Annotation, or Cluster.

“Entity Type”, as used herein, refers to a class of Entities that may be represented as being associated with a Map, for example the class of all Nodes, or the class of all Edges, or any other Entity of a Map.

“Map” as used herein refers to a collection of one or more Nodes and optionally one or more Edges. Mind Maps and Concept Maps are subsets and types of Map.

A “Branch” as used herein refers to a set of Nodes and Edges. Branches may be simple sequence of Nodes and Edges, may have single or multiple Edges from a single Node, and may include circular relationships, for example where following some sequence of Edges within the Branch leads back to a prior Node in the same Branch.

“Cluster”, as used herein, refers to a visually delineated region which has been configured by automated program logic or by user interaction with the present invention to contain other Map Entities or Content. The term “Node” is used herein inclusively to denote both Node and Cluster and should be understood to mean either Node or Cluster unless explicitly denoted to be a Cluster.

A Pointing Device, as used herein, denotes any device provided for selecting, moving, or activating indicia which are represented in some form on a display device. Examples of Pointing Devices include but are not limited to: a finger used in conjunction with a touch-screen device, a computer mouse, trackball, keys of a computer keyboard used singly or in combination, and voice commands in conjunction with when used in conjunction with a system or method capable of interpreting said voice commands. Any other device or devices which can be used to fulfill the function of selecting, moving, or activating Software objects represented on a display device are included in the definition of a Point Device for the purposes of the present invention.

“Software”, as used herein, refers to non-tangible instructions typically stored in computer memory.

“Browser” as used herein, refers to any content displaying device, whether said display is a physical device, mechanism, or apparatus; using computer instructions or any other method as long as said display is capable of visual display of one or more Maps.

“Extensible Markup Language”, XML herein, is a language that defines a set of rules for encoding documents in a format that is both human-readable and machine-readable.

“Hypertext Markup Language”, HTML herein, is a standardized system for embedding text representations into text files to indicate font, color, graphic, and hyperlink effects when said text file is displayed by a Browser, for example <h1> and </h1> to indicate the beginning and ending, respectively, of a header to a displayed page.

“Scalable Vector Graphics”, SVG herein, is a format for graphics that has support for interactivity and animation. The SVG specification is an open standard developed by the World Wide Web Consortium (W3C) since 1999. SVG images and their behaviors are defined in text files.

“Cascading Style Sheets”, called CSS herein, is a language used for describing visual characteristics and formatting of a document written in a markup language, said markup language including but not limited to HTML and SVG.

An “Application Programming Interface”, API herein, is a construct in computer programming which specifies how some Software components should interact with each other, typically used to allow one or a plurality of first Software components to execute functionality, optionally to send data input, and optionally to receive data output from one or a plurality of second Software components, where said Software components may be embodied as instructions in memory or storage coupled with the same computer or with a plurality of computers connected by one or more telecommunications links.

A “Database”, as used herein, refers to an organized collection of data. The data are typically organized to model relevant aspects of reality in a way that supports processes requiring this information. For example, modeling the status of users of a Software product in a way that supports generating a list of users whose accounts are currently active. (Source: http://en.wikipedia.org/wiki/Database)

The “Document Object Model”, DOM herein, is an application programming interface (API) for valid HTML and well-formed XML documents. It defines the logical structure of documents and the way a document is accessed and manipulated. In the DOM specification, the term “document” is used in a broad sense—increasingly, XML is being used as a way of representing many different kinds of information that may be stored in diverse systems, and much of this would traditionally be seen as data rather than as documents. Nevertheless, XML presents this data as documents, and the DOM may be used to manage this data.

“Back Buffer”, as used herein, comprises a data structure representing an allocation of Memory non-exclusively containing data which is not visible on a Browser or other display device, to which a graphical representation can be first transferred for the purpose of quick transfer to an area of Memory which contains data visible on a display device. The use of a Back Buffer yields lower drawing times and reduces flickering of visible objects as the display device is being updated.

“Front Buffer”, as used herein, is functionally and structurally similar or identical with a

Back Buffer, with the exception that it is visible in a Browser or other display device.

“Render Buffer”, as used herein, refers to a Back Buffer or Front Buffer without distinction.

“Tree-based data structure”, as used herein, refers to a structure comprising data-containing elements (traditionally called “nodes”, a term we will eschew to avoid confusion with Nodes of a Map) and connections between such elements that obeys the following constraints: 1) There is a single specially-designated “root” element; 2) each element may have connections to at most N other such elements (“children”), where N is a fixed constant; 3) for any non-root element, there exists a single path of connected elements from the root to that element. The latter constraint implies that the structure is acyclic, i.e., it is not possible to start at an element, follow a path of connected elements from it, and eventually return to the starting element. In laymen's terms, a tree represents a strict hierarchy.

“Quadtree”, as used herein, refers to a tree-based data structure where every element has exactly zero or four children (N=4), and is used to partition a two-dimensional (planar) region into subregions. The root of the quadtree represents the entire region, each of its children represents one quadrant of the region, each of its “grandchildren” represents 1/16 of the region, and so on. Geometric objects present in the region to be partitioned are stored at the “leaves” of this tree (elements with no children). The quadtree structure allows the rapid search for, and discovery of, all geometric objects lying within any arbitrary portion of the region.

“Entity Locator”, as used herein, refers to a data structure that is part of the present invention—an improved Quadtree. Traditionally the geometric objects stored in a Quadtree are points in the 2D plane, but in the present invention the quadtree manipulation algorithms have been enhanced to store any two-dimensional figures.

“Zoom Factor”, as used herein, is a positive number referring to the degree of magnification of a visual display. A Zoom Factor of 1 represents “original size”, neither magnified nor reduced in size. A Zoom Factor greater than 1 represents magnification and a Zoom Factor less than 1 represents size reduction. The quadtree structure allows the rapid search for, and discovery of, all geometric objects lying within any arbitrary portion of the region.

“Dragging”, as used herein, refers to the action of a user interacting with a display interface for the purpose of moving a visible representation of an object or a visible representation of data from a first display position to a second display position. One example of Dragging would be using a pointing device to send a message or an “event” recognizable to instructions capable of recognizing said events or messages, for example the “mouse down” event which is recognizable by instructions written using the Javascript language. The Dragging mechanism of the present invention may execute a Dragging operation by moving said representation of an object or data to a new position on the visible display when notified of a “mouse down” event followed by one or more “mouse move” events initiated by a pointing device, which would indicate that a button has been pressed and said device moved while the button remains depressed. Other actions or sequences may also initiate a Dragging operation in the present invention, for example but not limited to using a touch interface common in mobile devices. The actions or sequences used to initiate Dragging are not part of the present invention and the present invention, to include the Dragging operation, is not in any way constrained by the user actions that may initiate operations described herein, to include Dragging.

### 2. Best Mode of the Invention

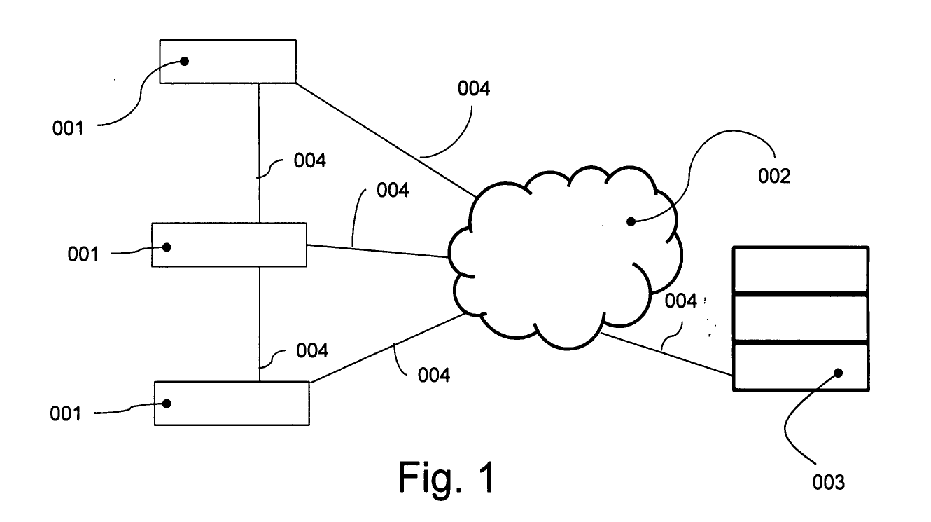

FIG. 1 describes the system components of the present invention. In one preferred embodiment, telecommunication links 004 connect computing devices 001, for example pad computers, laptops, smart phones and other computer devices, via network 002 to computing servers 003. In an alternate embodiment, computing devices 001 are connected in a peer-to-peer manner with each other, in which case the server software is embodied on one or more of the devices 001. The present invention may be implemented on a single computer or distributed among a plurality of computers with the appropriate telecommunication channels required to effect communication between the modules according to their distribution.

### 2. How to Make the Invention

Nodes and Edges contained with a Map may be created, deleted, modified, annotated, repositioned, duplicated, or merged. These operations can be accomplished either automatically by Software, manually by the user, by the user with Software assistance, or by Software programs distinct from the present invention via the provided Application Programming Interface. For example, the user may reposition or resize a single node and the Software will automatically reposition attached Edges, nearby Nodes, labels, and annotations to accommodate the user's action. Nodes and Edges may also be repositioned automatically by the Map Client or the Map Server according to various criteria at the request of the user. Positioning criteria include vertical or horizontal Node placement, minimisation of Node overlap, minimisation of Edge intersections, and changes in underlying data, applications, media or documents from which a Map is generated.

The present invention includes both client (Map Client herein) and server (Map Server herein) components which may reside on a single computing device or on one or more separate computing devices connected by telecommunications link. In one preferred embodiment the client Software runs on a local computer, tablet, or mobile device in a web browser and the client and server communicate over a network using standard communication protocols.

A preferred embodiment of the present invention comprises instructions executing on one or more network-connected, tangibly-embodied computers connected by a telecommunications protocol. Instructions of the present invention may be categorized as one or more Map Client components and one or more Map Server components. One or more users interact with the Map Client using standard computer input devices or Pointing Devices (for example but not limited to mouse, keyboard, touchscreen, and/or voice command) and one or more output devices (for example but not limited to touchscreen, pad, telephone, wrist watch, television, video device or monitor). The Map Server contains or is coupled to data storage for perpetuating and maintaining data together with instructions for adding, deleting or modifying such data and for generating responses to user-generated client requests based upon said stored data. The Map Client contains instructions for generating requests for retrieving and manipulating data to the Map Server based upon user input, displaying data received from the Map Server, for optionally keeping locally a copy or copies of said data, and for modifying said data based upon user input. The Map Client and the Map Server are optimally but not necessarily embodied on separate processing machines connected by one or more telecommunications links.

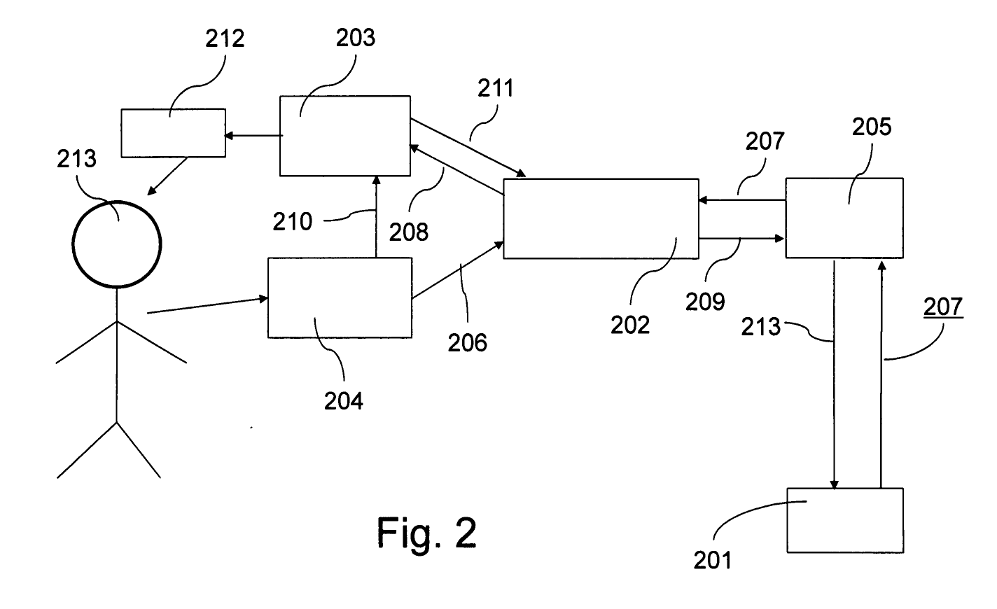

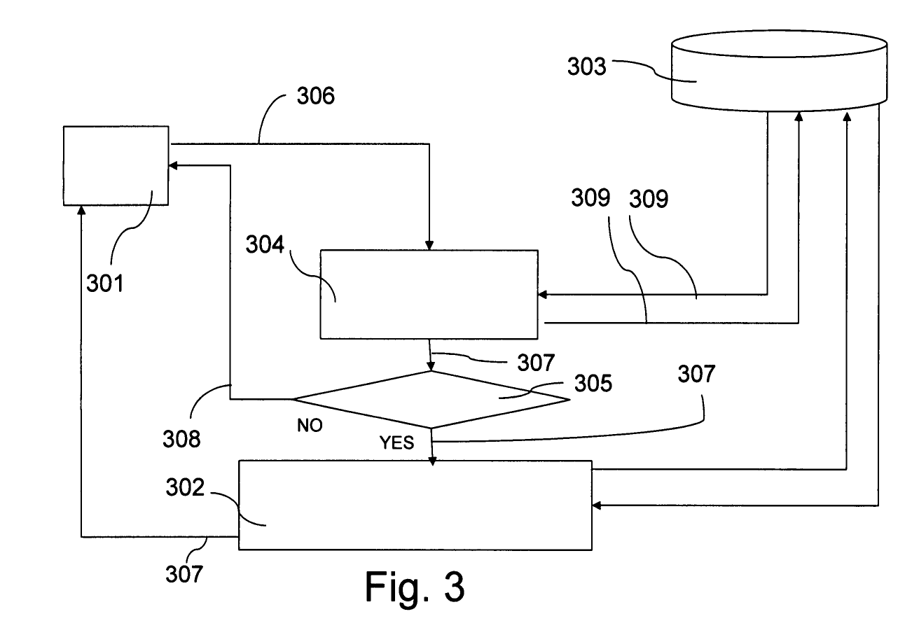

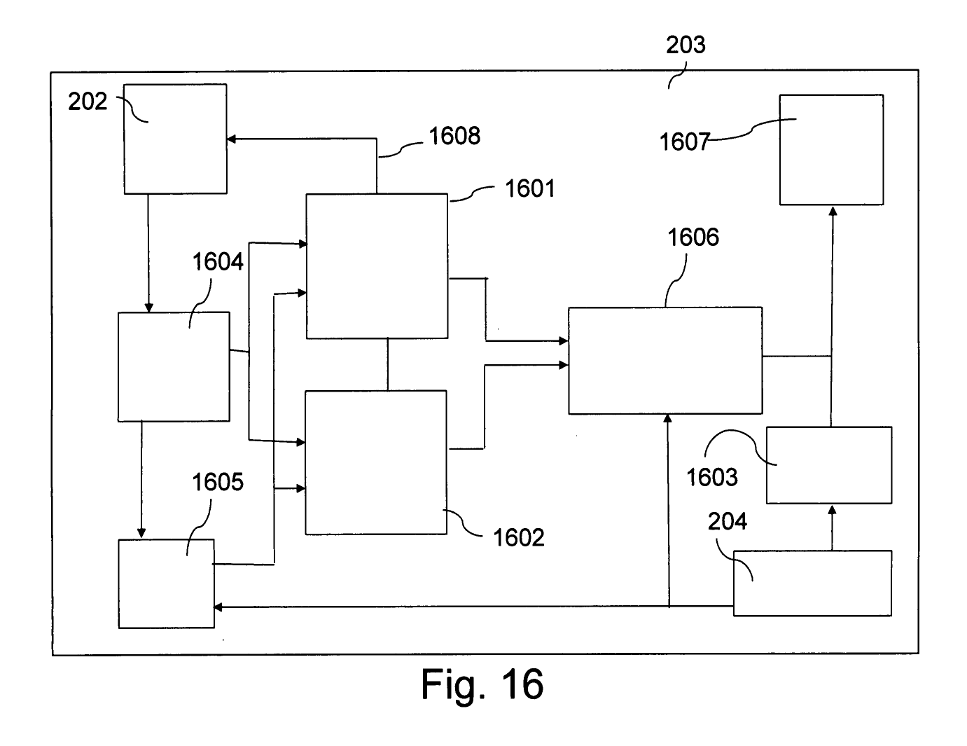

FIG. 2 describes the Software architecture of the Map Client in one preferred embodiment of the present invention. Map Server 201 is described in detail in FIGS. 3 through 5 in their entirety. Local Map model 202 represents Software that records the state of Maps open in the application at any given time. Local Map model 202 responds to locally-initiated map change requests 206 received from the gesture interpreter 204 and external change instructions 207 received from the Map Server 201 via the sharing manager 205. Local Map model 202 transmits notifications 208 to the rendering engine 203 whenever a change is made to a Map so that the Map may be redrawn correctly on the screen. Local Map model 202 transmits provisional change requests 209 to the Map Server 201 via the sharing manager 205 whenever a local change is made to a Map so that the change may be recorded in the Map Server 201 database and so that collaborating Map Clients may be notified of the change. It responds to visibility queries from the rendering engine 203 as described below. Rendering engine 203 represents Software that draws a section or the entirety of the currently viewed Map on a display device. It responds to notifications 208 of changes to the Map received from the local map model 202 by updating its back buffer (see FIG. 16). Upon receiving a redraw request 210 from the gesture interpreter 204 to redraw the Map, it schedules the redraw for an appropriate time. Before redrawing, it sends a visibility query 211 to the local map model 202 for those Entities in the Map which fall within the visible screen area, in order to minimize rendering time and memory usage. Gesture interpreter 204 reacts to input device events (for example key presses, mouse movements and clicks, and touchscreen actions performed by user 213), combines these events and interprets them as user gestures, and determines the effect such gestures should have. For each gesture that should result in modifications being made to the currently viewed Map, one or more change requests 206 are sent to the local map model 202. Once all requests have been satisfied, a notification 208 is sent to the rendering engine 203 requesting the display 212 to be redrawn to reflect the changes. Display 212 may be viewed by one or more users 213. Sharing manager 205 communicates with the Map Server 201 to coordinate sharing of a Map across multiple Map Clients executing on different computers. When it receives provisional change requests 209 from the local map model 202, it transmits those messages 213 in a form that can be parsed by the Map Server 201. When it receives committed change requests 207 from the Map Server 201, it translates them back into the form used within the Map Client and checks whether they conflict with any provisional changes 209 yet to be sent to the Map Server 201. If such conflicts exist, the corresponding provisional changes are invalidated and the user is notified. In either case, the committed change requests 207 are sent on to the local map model 202 for incorporation into the local Map.

FIG. 3 describes the Software architecture of the Map Server in one preferred embodiment of the present invention. Signifier 301 represents a Map Client as described in FIG. 2. This is an “originating” Map Client, meaning it is the source of changes to a Map, in this example in response to input. Change request handler 302 handles the various changes requested by the Map Client, for example to change the position of a Node, to change a Node's color, to define an Edge between two Nodes, or any other changes that may be made by a Map Client to a Map. Change handling within handler 302 may be provided in the form of Software functions, object oriented Software classes, switch statements, or any other Software construct without restriction. Optional associated Database 303 may contain a data representation of a Map or Maps. In one preferred embodiment this Database is a relational database such as MySQL™, Oracle™, SQL Server™ or other relational database wherein tables are defined for Nodes, Edges, Comments, Users, and other aspects of a Map or Maps, and in which rows would contain identifying data for each item, for example a Node, an Edge, etc. Other embodiments may use a non-relational database, graph database, differing types of data repositories, computer memory, or flat files to store the data pertaining to the Map or Maps. Conflict and permissions handler 304 dispatches change requests 306 from the Map Client 301 to appropriate change handlers within change request handler 302. In one preferred embodiment, conflict and permissions handler 304 accepts requests in the form of JSON objects. Conflict and permissions handler 304 may also accommodate other remote protocols such as representational state transfer (REST), simple object access protocol (SOAP), remote procedure call (RPC), enterprise java beans (EJB), and others without violating the intended functionality of this invention. Conflict and permissions handler 304 checks the requested Map change 307. For example, if it is requested that a Node is deleted, Conflict and permissions handler 304 may check the ownership data of said Node, optionally by querying and retrieving data 309 about the Node in question from Database 303, and comparing said ownership data against defined permission rules. These rules may be defined as desired and kept in the form of instructions or computer data in various forms such as Database or computer file. Conflict and permissions handler 304 finds that the change request 307 is not valid, it returns a notice of invalidity 308 to Map Client 301; otherwise, change request 307 is sent on to change request handler 302. Reference 305 indicates the succeed or fail decision reached by conflict and permissions handler 304. Finally, if change request handler 302 is successful change request 307 is forwarded to Map Client 301 along with indication of whether or not it is valid.

In one preferred embodiment, both the Map Server and Map Client represent each Node as a data object with the following properties:
Unique identifier (for example a positive integer).
List of incident Edges (Edges connected to this Node).
Logical location of center of node (for example a unit-less two-dimensional Cartesian vector).
Logical size (for example a unit-less Cartesian vector).
Logical shape (for example a predefined shape name or user-provided image reference).
Drawing attributes (for example, but not limited to, background and border colors, Boolean switches to enable borders, drop shadows, and others.)
Content (in one embodiment, an HTML or text string)
Annotations (in one example, text strings)

The Map Client creates at least one DOM block-display element for each Node, into which the Content is inserted. The use of DOM block-display elements to render Nodes allows those Nodes to hold any type of Content that may be displayed by the web Browser or other visual display; this stands in contrast to existing Software, which typically use HTML Canvas, SVG, or Flash™ technologies, all of which limit the types of Content that may be included. Furthermore, DOM elements are rendered directly by the Browser or other visual display, producing a significant speed advantage over approaches using HTML Canvas or Flash™, which require interpreted program logic to perform most rendering computations. The major drawback of using DOM elements is a lack of scalability; the rendering performance of Browsers and other visual displays generally degrades quickly when the number of DOM elements in a page is very large. The present invention includes effective solutions to this problem.

The Map Client also creates one or more Render Buffers, which are DOM block-display elements used to hold all of the aforementioned elements corresponding to Nodes that are to be rendered at a given time.

In one preferred embodiment, both the Map Server and Map Client represent each Edge as a data object with the following properties:
Unique identifier (for example an integer).
Identifiers of the edge's two endpoints. Generally both endpoints will be Nodes, but for limited times (such as during Edge creation and repositioning), one endpoint may be a point in the plane (for example a Cartesian vector).
Logical edge thickness (for example a positive number).
Logical shape (for example a straight line, Bezier curve, or spline composed of one or more lines and/or curves).
Pattern (for example solid, dotted, dashed).
Drawing attributes (for example color, arrowhead and arrow tail shape descriptors)
Label (for example a text string).

The Map Client additionally creates at least one SVG shape element for each Edge. The use of SVG shape elements to render Edges allows those Edges to take on the desired shape and to have labels that are themselves shaped to fit the Edge. SVG elements are also rendered directly by the Browser or other visual display, producing a speed advantage over approaches that use HTML Canvas or Flash™, which require interpreted program logic to perform most rendering computations.

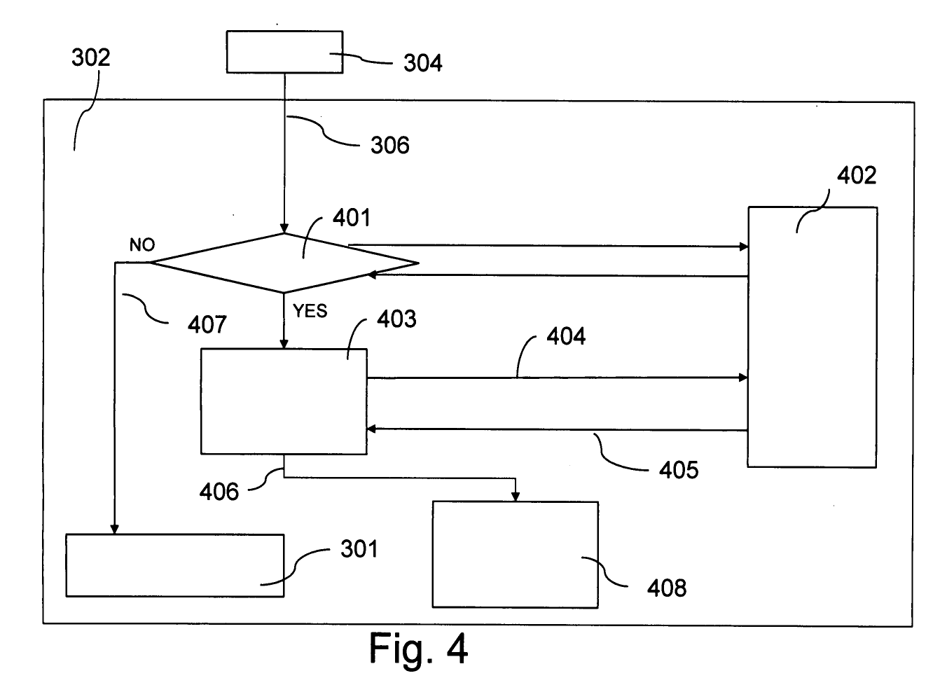

FIG. 4 illustrates a detail view of change request handling module 302 in FIG. 3. It validates that there exists a function or module capable of fulfilling the change request 306, received from conflict and permissions handler 304 in FIG. 3, and if so, executes that function, then returns one or more results. Decision point 401 comprises a lookup of available change request handling methods or functions 402. If a suitable method or function is not found, the change request 406 along with a notification error are passed (407) to originating Map Client 301. If a suitable method or function is found, however, the step 403 of executing the found change request handling method ensues, passing any optional parameters 404 included in said change request to the relevant change request handling method 402 and receiving the result 405. The change request 406 is subsequently passed to change request broadcaster 408.

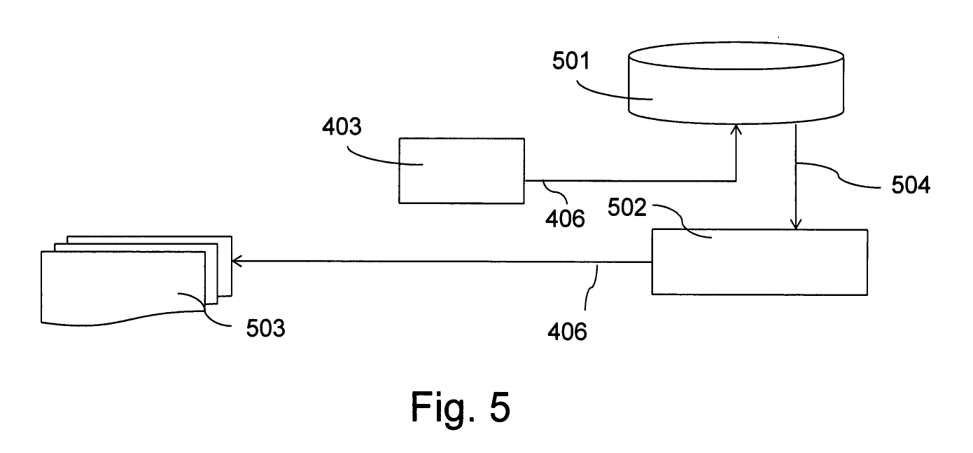

FIG. 5 depicts greater detail of change request broadcaster 408. Database 501 may be incorporated into Database 303 or may exist as a separate entity. Database 501 is a repository of change requests 406 received from the step of executing appropriate change handler Software 403 (FIG. 4). Database 501 is maintained for the purpose of notifying identified Map Client listeners of changes to Maps to which said Map Client listeners have access. Said broadcasts may occur at desired intervals, but in a preferred embodiment new change requests inserted into Database 501 are immediately broadcast to one or more listening Map Clients 503 by change request broadcaster 408. There are many methods that change request broadcaster 408 may use to broadcast to the listening Map Clients, web sockets among them, any of which can be used without departing from the scope of the present invention.

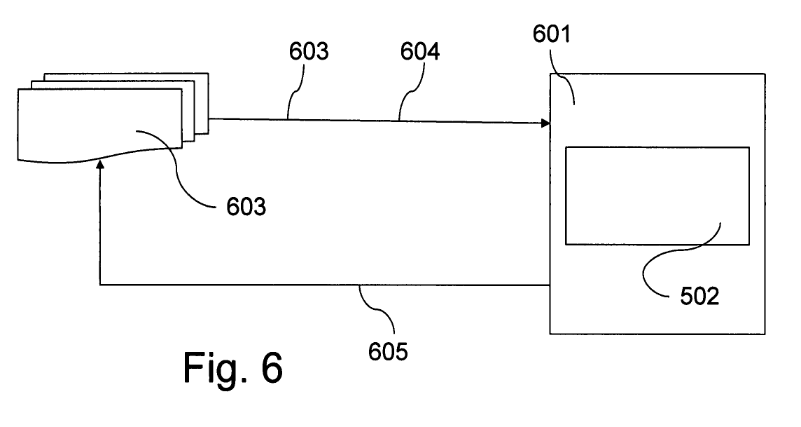

FIG. 6 represents the process by which one or more listening Map Clients are made known to a Map Server. Map Server 601 invokes change request broadcaster 502 (see FIG. 5), which performs communication of one or more change requests 605 to one or more listening Map Clients 603. Said listening Map Clients 603 are registered with change request broadcaster 502. In a preferred embodiment this registration happens along with a login or authentication step 603. Registration may also happen in a separate step temporally separate from the sequences described in FIG. 6. Login or authentication may be by any method the Map Server 601 or change request broadcaster 502 require, for example OAuth™, or with username and password, with a proprietary token scheme, or by any other method. In a preferred embodiment, a Map identifier 604 of the Map for which the Map Client wishes to receive change requests will be passed to change request broadcaster 502 as part of the login request 603.

Two or more local or physically separated users may collaborate on a Map. Each user may perform any of the Map operations described herein. Each user may see the result of every other user's operation in near real time. This is accomplished using telecommunications links between one or more central Map Servers and each said user's Map Client. When a user of a given Map Client alters a collaborative Map, the resulting Map alterations are propagated to the remaining Map Clients currently displaying the same Map.

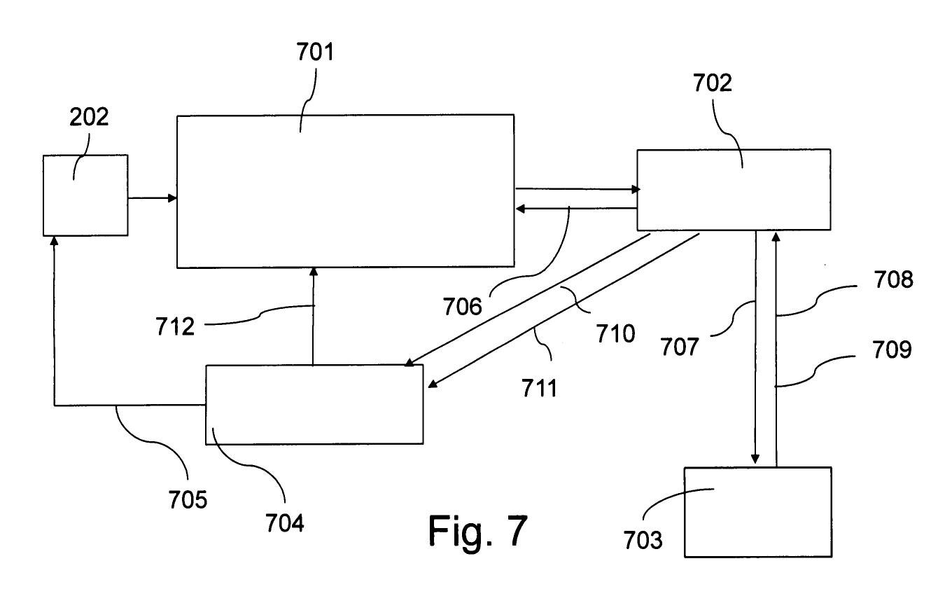

FIG. 7 describes the internal architecture of the sharing manager 205 of FIG. 2 in one preferred embodiment of the present invention. Queue 701 represents a queue of provisional change requests received from the local map model 202. Server protocol handler 702 handles the translation of change requests to and from the format understood by the Map Server 703. Map Server 503 is equivalent to Map Server 201 of FIG. 2. Server protocol handler 702 can invalidate (706) change requests in provisional change queue 701, or send said change request 707 on to Map Server 703. Map Server 703 may handle said change request as described herein and return the committed change request 708 back to server protocol handler 702. In the case that Map Server 703 cannot handle the change request for whatever reason, it returns a change invalidation 709 to server protocol handler 702. Conflict detection and resolution module 704 is responsible for detecting conflicts between provisional changes 710 not yet sent to the Map Server 703 and committed changes 711 received from the Map Server 703, invalidating any provisional changes involved in a conflict, and notifying (705) the local map model 202 of both committed changes and invalidations of provisional changes. Change request invalidations 712 are also forwarded to provisional change queue 701 by conflict detection and resolution module 704.

The portion of the Map displayed to the user at any given time is bounded by a rectangle referred to herein as the Viewport. The present invention only draws to the screen the portion of the Map within the Viewport, dramatically reducing rendering time and thereby enabling the display of large Maps.

The contents of the Viewport are magnified to fill the physical area of the Browser or other visual display allocated for the display of the Map. The degree of magnification is referred to herein as the Zoom Factor. The user may increase the magnification, and thus reduce the size of the Viewport, by invoking the Zoom In feature, and likewise may decrease magnification and increase Viewport size by invoking Zoom Out. The user may also move the Viewport in any direction by invoking the Pan feature.

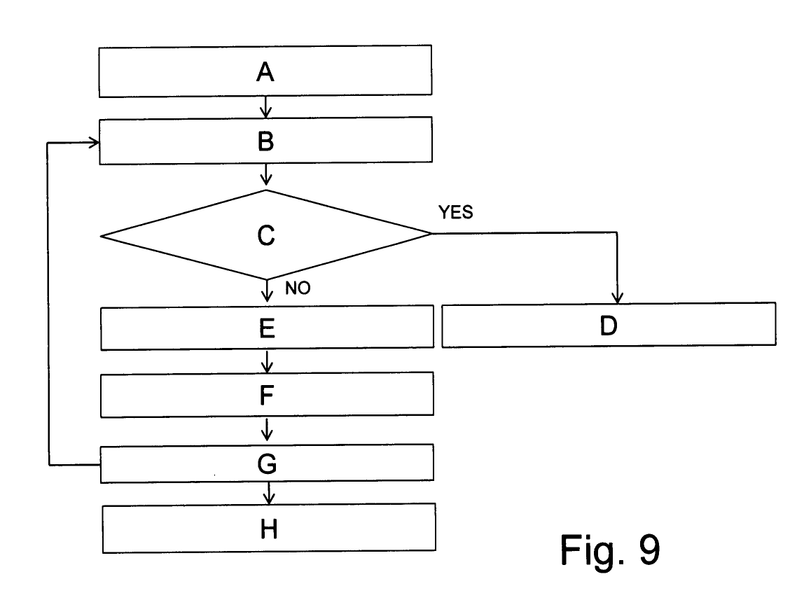

To obtain typically logarithmic query time for discovering what lies within the Viewport, all Map Entities are stored in one or more Entity Locators. FIGS. 9, 10, and 11 describe the algorithms for initial construction of, querying of, and insertion into the Entity Locator, respectively. Every object representing a shape exposes a predicate function that determines whether the shape intersects a given axis-aligned rectangle. For additional speed, inexact intersection functions that perform fewer computations and produce more false positives (but zero false negatives) are used when exact functions would be too computationally expensive (for example, for irregularly shaped nodes and Bézier-curved edges). The height of the tree is controlled by a leaf size threshold: the upper limit on the number of Entities that can be stored at a Quadtree leaf node. The higher the threshold is set, the shorter the tree will be, but also the longer it will take to search a leaf node. In a preferred embodiment of the present invention, the threshold has been set to 10 in accordance with the results of performance trials.

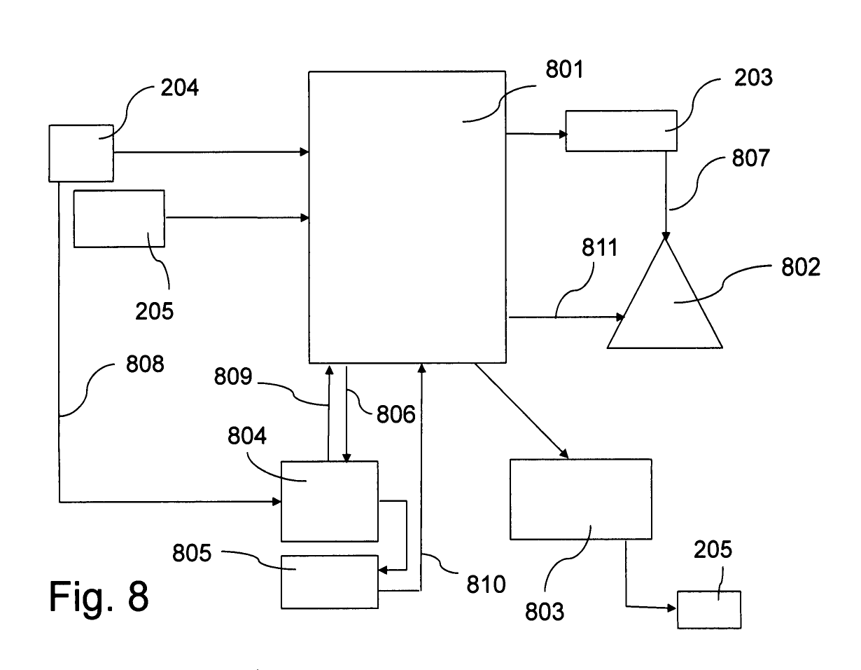

FIG. 8 describes the internal architecture of the local Map model 202 of FIG. 2 in one preferred embodiment of the present invention. Map Entity storage 801 contains data structures which store information about the Entities associated with a Map, for example Nodes, Edges, and Clusters. When Map Entity storage 801 receives a change request of any type, for example from sharing manager 205, it validates the request, modifies the contents of its data structures as appropriate, and notifies the Entity locator 802 and rendering engine 203 (from FIG. 2). For changes originating from the local gesture interpreter 204 (from FIG. 2), it also notifies the change transaction queue 803, generates an inverse change request (which, if issued, would undo the effect of the present change), and transmits the inverse change request 806 to the undo transaction stack 804. For changes arriving from an external Map Client, these latter three steps are not necessary. Note that a single change request may require multiple changes to the data structures and thus give rise to multiple change notifications. Entity Locator 802 stores the coordinates of Map Entities in a Quadtree-based data structure, so as to support rapid response to visibility queries 807 from rendering engine 203, as described above. Entity Locator 802 also receives location updates 811 from Map Entity storage 801. Change transaction queue 803 aggregates individual change notifications into transactions, representing the effects of one or more change requests stemming from a single user action. Transactions are sent one by one to the sharing manager 205 (from FIG. 2) as provisional change requests. Undo transaction stack 804 aggregates individual inverse change requests 808 into transactions 809, which may be used to undo the effects of user actions. Upon user demand, transactions are removed in a last-in, first-out order and issued as if they were ordinary changes. Redo transaction stack 805 stores the inverse of inverse change transactions, which may be used to reproduce the effects of user actions that have previously been undone. As with the undo transaction stack 804, the redo transaction stack 805 issues transactions in a last-in, first-out order as ordinary changes.

FIG. 9 depicts the steps of the algorithm followed when constructing the Entity Locator, upon loading of a Map into the Map Client. The inputs are a set of Entities and a Quadtree leaf size threshold. First step A of said algorithm comprises the determination of the maximum and minimum x- and y-coordinates from among the set of Map Entities; these are used to construct an axis-aligned bounding rectangle which the Entity Locator will spatially divide. Then, a recursive procedure is initiated which returns the root of a Quadtree covering the entire bounding box. The recursive procedure begins with step B, which creates a root element representing the entire area. Step C checks whether the number of Map Entities falling within this area is below a specified threshold. If so said Map Entities are simply stored in the root element and in step D said root element is returned as a single-element tree (a “leaf”). If the number exceeds the threshold, step E divides the area is divided into four equal-sized quadrants, B0, B1, B2, B3 for purposes of illustration, and stores coordinates of dividing lines in the root node. Step E leads directly to step F, which assigns each Map Entity to the quadrant or quadrants it intersects. Step F leads directly to step G, which recursively invokes step B four times using the intersecting Entity set and bounding box of each quadrant. Each recursive path exits by executing step H, in which the trees returned from the four recursive calls are attached to the root element as child subtrees. The output of the algorithm depicted in FIG. 9 is a Quadtree.

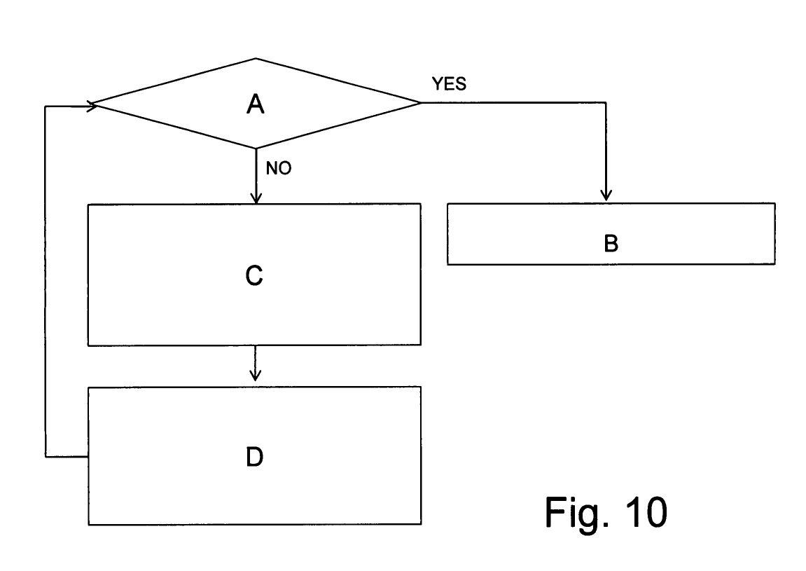

FIG. 10 depicts the algorithm followed when locating Map Entities in a specified target region. The inputs are Quadtree Q and a target region bounding box T. Note that the target region is not related to the region covered by Q, nor to any of its subtrees. The query begins at the root element of the Entity Locator and employs a recursive procedure. First step A of said algorithm is the determination of whether the element currently being examined is a leaf. If said element is a leaf, step B is executed which checks each Map Entity stored in said element for intersection with the target region and adds said Map Entity to the output if found to be intersecting. If said element is not a leaf (and thus contains no Map Entities directly), step C uses dividing line coordinates stored at the root of Quadtree Q to determine which quadrants intersect of said element intersects with the target region, and step D invokes recursively invokes step A for each quadrant found to be intersecting. The output of the algorithm depicted in FIG. 10 is a list of Map Entities intersecting target T.

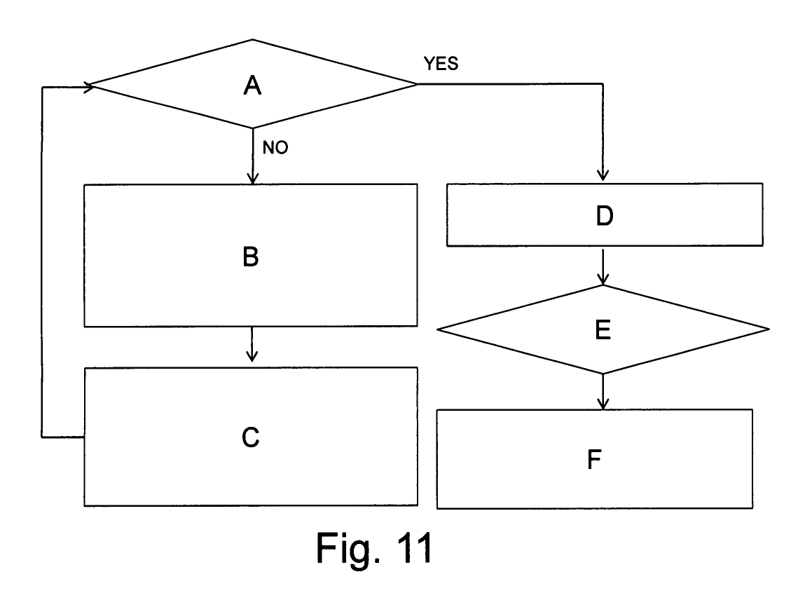

FIG. 11 depicts the algorithm followed when inserting a new Map Entity into the Entity Locator. The inputs to said algorithm are Quadtree Q, the Map Entity to be inserted e, and a Quadtree leaf size threshold L. The insertion begins at the root element of Quadtree Q and employs a recursive procedure. First step A of said algorithm is the determination whether the element e currently being examined is a leaf. If e is not a leaf, step B is executed in which Map Entity e is checked for intersection with each of the four child quadrants of Q using dividing line coordinates stored at the root of Q, and step C is executed. Step C recursively invokes step A at each quadrant of Q found to be intersecting with e. If step A finds element e to be a leaf, step D stores e in the root of Q; and step E then then determines whether the leaf has been overfilled, which would slow down query performance. Step E compares the number of Map Entities now stored at the leaf to the leaf size threshold used during Quadtree construction, and if the number of Map Entities exceeds said threshold, step F is invoked. Step F consists of the Entity Locator construction algorithm (see FIG. 9) invoked on the region represented by the leaf element e and the set of Map Entities stored at the leaf. The resulting tree replaces the leaf e in the Entity Locator.

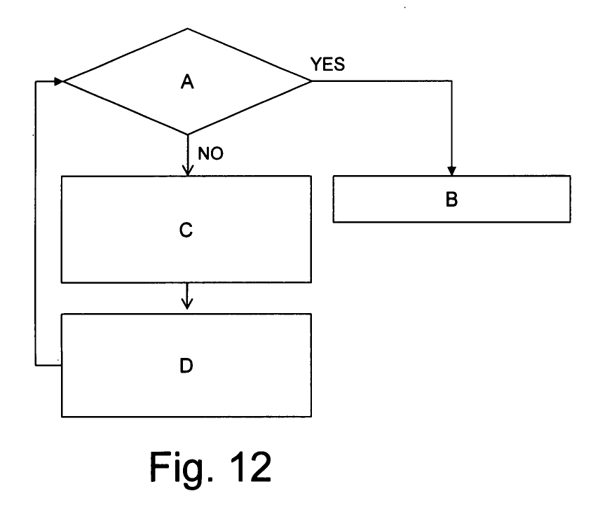

FIG. 12 depicts the algorithm followed when a Map Entity e is to be removed from the Entity Locator 802 (see FIG. 8). First step A of said algorithm begins at the root of the Entity Locator 802 Quadtree Q and checks whether said root is a leaf. If step A finds that said root is a leaf, it contains a list of Entities falling into the region it represents, and step B executes. Step B simply removes e from said list. If said root is not a leaf, it has four subtrees corresponding to the four quadrants of the region it represents. If said root is not a leaf, step C is executed and uses dividing line coordinates stored at the root of Q to determine which quadrants intersect e. Subsequent to step C, step D recursively invokes step A for each quadrant intersected by e.

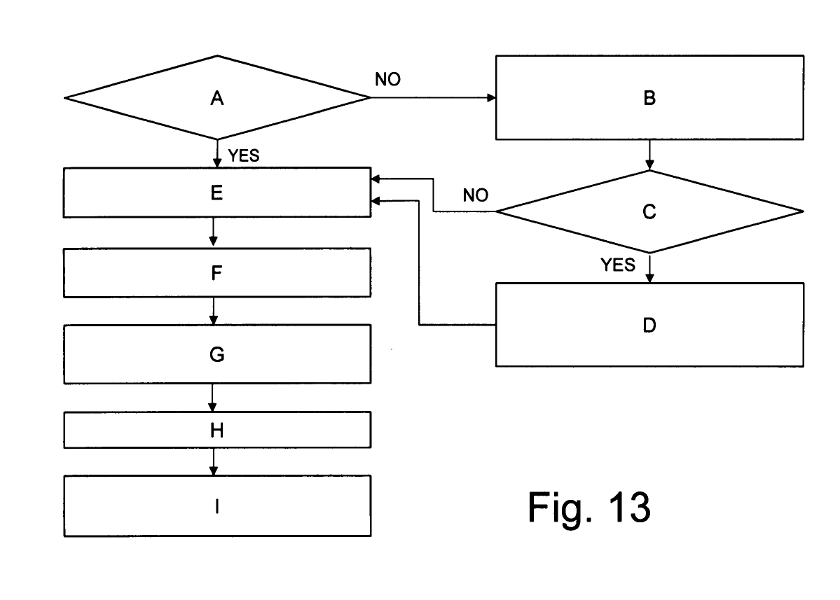

FIG. 13 depicts the algorithm followed when a new Map Entity is created in the map. The inputs to said algorithm are a) one or more Map Entity identifiers, but only if entity creation is either: part of an undo transaction (identifier is that of previously deleted entity) or part of transaction received via Map Server, and b) Map Entity Type.

If the Map Entity was created by a different user of this shared map, or if it is the result of undoing the deletion of a Map Entity, it will already have a valid identifier. First step A of said algorithm is a check for said identifier. If the Map Entity was just created for the first time on the current client computer, step A will not find a valid identifier and step B is invoked to obtain a new identifier from a list of provisional identifiers that have previously been received from the Map Server. If this list is empty as ascertained by logic C, step D requests a request for more provisional identifiers is placed to the server and waits for the response before proceeding. Once an identifier is available to step D, step E is invoked to issue a Map Entity deletion change request (the inverse of creation) which stored on the Undo Transaction Stack 804 (FIG. 8). Step E then evokes step F to allocate memory and initialize a Software object to represent the new Map Entity. Step F invokes step G to store said new Map Entity in a lookup table appropriate to its type (Node, Edge, etc.). Step G then invokes step H to insert said new Map Entity into the Entity Locator 802 (see FIG. 8) and step H invokes step I. Step I sends a Map Entity creation change request to the Map Server.

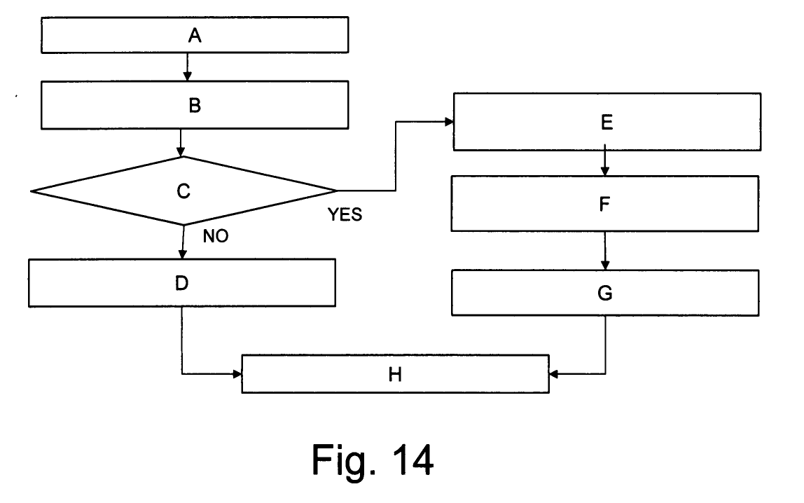

FIG. 14 depicts the algorithm followed when one or more existing Map Entities are modified. The inputs to said algorithm are a) one or more Map Entity identifiers, type of modification, and additional inputs specific to the type of modification. First step A of said algorithm finds the Software object representing the Map Entity by looking it up in the table appropriate to its type (Node, Edge, etc.). Step A then invokes step B, which computes an inverse change request for the current modification and stores said request on the Undo Transaction Stack 804. Following step B, step C is Software logic to determine whether the Map Entity's location is being modified. If Step C determines the Map Entity's location is not being modified, step C invokes step D to apply the modification now to the Software object representing the Map Entity. Step D also invokes H to send a Map Entity modification change request to the server. If Step C determines the Map Entity's location is being modified, step C invokes step E to remove the Map Entity from the Entity Locator 802 (see FIG. 8). Step E then invokes step F, which applies the modification is applied to the Map Entity Software object. Step F then invokes step G, which reinserts said Map Entity into the Entity Locator 802 (see FIG. 8). Step G invokes step H which sends a Map Entity modification change request to the Map Server.

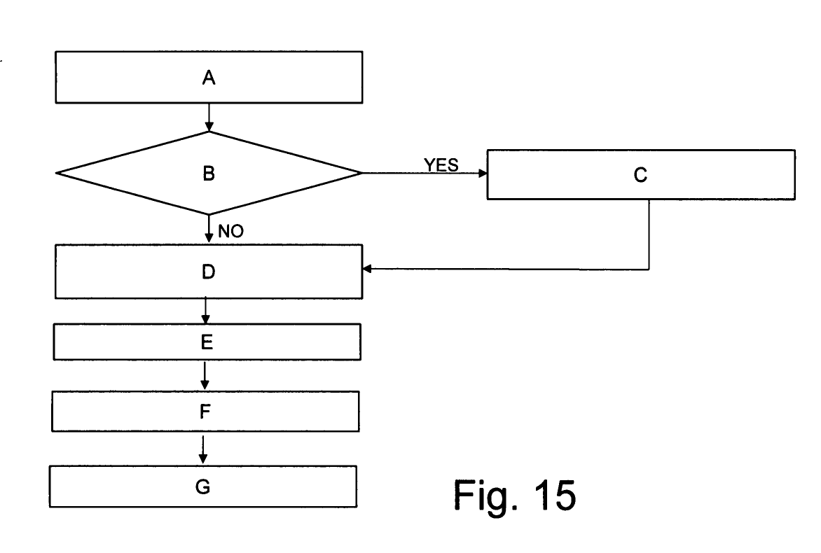

FIG. 15 depicts the algorithm followed when an existing Map Entity is deleted. The input to said algorithm is a Map Entity identifier. First step A of said algorithm looks up the Software object representing said Map Entity is found by looking it up in the table appropriate to its type (Node, Edge, etc.). Step A then invokes step B, which consists of Software logic to determine whether the deletion requires other Map Entities to be modified or deleted in order to maintain the logical consistency of the map. If step B returns an answer in the positive, step C is invoked to perform said modifications or deletions first (using the algorithms from FIGS. 14 and 15, as appropriate). In either case, following step B or step C, step D is invoked to compute a Map Entity creation change request (the inverse of deletion) and store it on the Undo Transaction Stack 804. Step D invokes step E to remove the Map Entity from Entity Locator 802 (see FIG. 8). Step E invokes step F to remove said Map Entity from its lookup table, and step F invokes step G to send a Map Entity deletion change request to the Map Server.

When the Map is rendered, the target Render Buffer is first cleared of any DOM elements it contains. The Entity Locator is then queried for all Map Entities whose shapes intersect the current Viewport. Each DOM element corresponding to one of those Entities is configured by translating the logical coordinates of the Entity into physical coordinates in the Browser or other visual display, based on the current Viewport position and Zoom Factor. Finally, the DOM elements are inserted into the Render Buffer (attached as children).

Browsers and other visual displays keep the set of DOM elements that are currently visible in a hierarchical data structure referred to herein as the DOM Tree. Rendering a web application's visual output by modifying the DOM Tree directly can be very slow, because the Browser or other visual display may need to translate the entire DOM Tree into a bitmapped (pixel-by-pixel) image after every change to said DOM Tree; this process is known as a “reflow”. In practice, Browsers and other visual displays attempt to optimize this process and reduce the number of reflows; however, complex web pages (such as a large Map) may still trigger many reflows, render slowly as a result, and thus flicker or respond sluggishly to the user.

In the present invention, Maps which contain large numbers of Nodes may be manipulated by program control or Pointing Device in order to improve or enable viewing on a display device of finite size through techniques including panning in multiple axes, zoom in, and zoom out. Zooming sets the scale of the Map including the sizes of the Entities within the Map, for example Nodes and Edges, without changing the boundaries of the Map.

FIG. 16 depicts the internal architecture of rendering engine 203 (see FIG. 2) in one preferred embodiment of the present invention. Render Buffers 1601 and 1602 build a DOM subtree with elements corresponding to visible Map Entities. In the present example two rendering buffers are depicted, but any number of Render Buffers are possible without departing from the scope of the present invention. In one preferred embodiment, Nodes and Clusters are drawn using regular DOM elements and styled using CSS; while Edges are drawn using SVG elements. Render Buffers 1601 and 1602 modify the DOM sub-tree in response to change notifications from the local map model 202 via change command multiplexer 1604, and also issue queries 1608 to local map model 202 to ascertain whether a given Map Entity is visible given the current pan and zoom positions of the viewport. Embed layer 1603 builds a DOM sub-tree consisting of embedded multimedia elements. To account for display device limitations, such elements are not rendered by the normal mechanism in the Render Buffers 1601 and 1602. Change command multiplexer 1604 consists of program logic which selects which Render Buffer is currently the Back Buffer, the Back Buffer being the one whose contents are currently not shown onscreen. Incoming change notifications are directed by change command multiplexer 1604 to the Back Buffer, as well as to change notification queue 1605. Change notification queue 1605 is a queue of change notifications that have already been delivered to the Back Buffer, but not the Front Buffer. It receives change notifications both from change command multiplexer 1604 and from gesture interpreter 204. After a render cycle is complete (the Front and Back Buffers have been swapped), the change notification queue 1605 delivers all queued notifications to the Render Buffer which has not yet received them. DOM output multiplexer 1606 consists of program logic which attaches the DOM sub-tree of the Front Buffer to the document displayed in the web Browser or other visual display 1607. Visual display 1607 is a web Browser or other visual display application or device within which the Map Client executes.

The present invention dramatically reduces reflows by employing a technique known as “double buffering”. The Render Buffer present inside the DOM Tree—the “Front Buffer” herein—represents the visible portion of the Map. A second Render Buffer outside the DOM Tree—the “Back Buffer”—is used to assemble a new view of the Map whenever any change must be made to what the user sees. By rendering outside the DOM Tree, no reflows are triggered. Once rendering is complete, the Render Buffers are “swapped”: the Front Buffer is removed from the DOM Tree and the Back Buffer is inserted in its place, in one step. This triggers a single reflow.

Removal and reinsertion of Render Buffers into the DOM Tree present complications in some Browsers or other visual displays when the Map content includes “embedded media” or “embeds” such as video, audio, and external web applications, particularly when said embeds are included by use of iframes. The Browser or other visual display may release all system resources associated with an embed when it is removed from the DOM Tree, and reclaim these resources when the embed is reinserted. For example, if a Node contains a video, the video will stop playing and restart whenever it is removed and reinserted. As this can happen very frequently, the result may be highly jarring for the user.

The present invention addresses this problem by keeping embedded media in a separate “Embed Layer” rather than in either Render Buffer. The Embed Layer is never removed from the DOM Tree; rather, when changes need to be made to how embeds are presented, the following process is followed:

1. The entire Embed Layer is hidden using the CSS display: none property.
2. All changes to embeds are performed.
3. The Embed Layer is made visible using the CSS display: block property.
This triggers two full reflows: one upon hiding the Embed Layer and one upon showing it. Changes made in the interim technically each trigger a reflow; however, modem Browsers or other visual displays are able to quickly detect that changes to a hidden element will not affect what appears on the screen, and thus abandon the reflow process at that point. The approach of using an Embed Layer, while not as efficient as the Double-Buffering scheme, is still efficient enough to allow responsive display of large Maps.

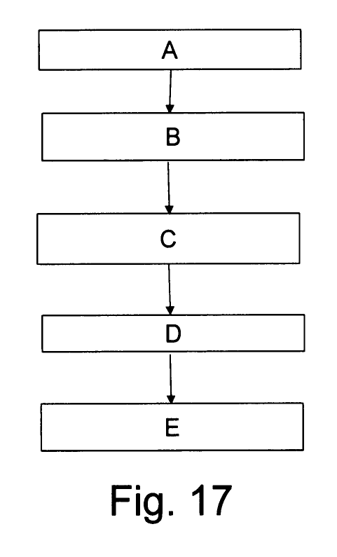

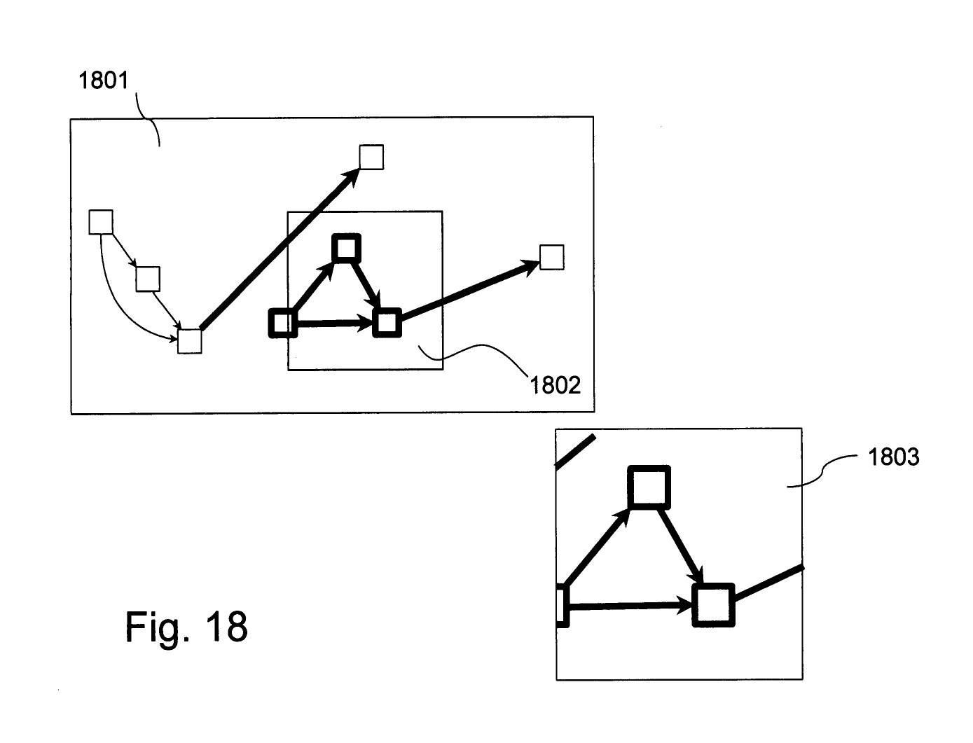

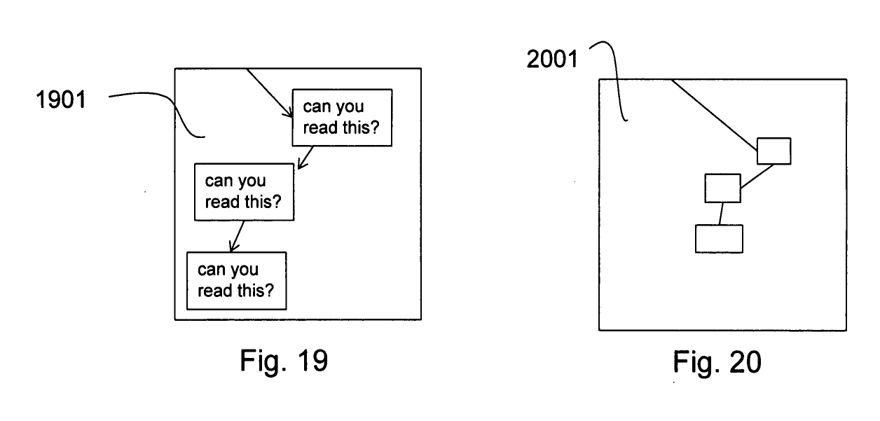

FIG. 17 depicts the algorithm executed when rendering engine 203 in FIG. 2 redraws to a visual display. The Back Buffer's DOM elements have already been configured to exhibit the non-positional properties of the corresponding Map Entities (this is done on receipt of change notifications). First step A depicted in FIG. 17 hides all DOM elements in said Back Buffer. Step A invokes step B, which queries Entity Locator 802 in FIG. 8 for Map Entities that intersect the virtual viewport 1802 in FIG. 18. For each visible Map Entity yielded by step B, step B invokes step C, which computes said visible Map Entity's size and position relative to the virtual viewport 1802. Step C uses the computed size to retrieve a detail level from a configuration table; larger sizes correspond to higher detail levels, so that Map Entities are visually simplified when they would be too small onscreen for users to notice their details, saving rendering time and allowing the display of arbitrarily large Maps (see also FIG. 19). Next, step C positions each of said visible Map Entity's corresponding DOM elements, and then un-hides said visible map Entities (the selected detail level determines which DOM elements are shown). Once all needed DOM elements are ready, Step C invokes Step D, in which the roles of the Front and Back Buffers are swapped; the former Back Buffer, now Front Buffer, is shown in the Browser or other visual display. Step D then invokes Step E, which delivers queued change notifications to the former Front Buffer, now Back Buffer, to synchronize it with the current state of the Map and prepare it for the next render cycle.

As a map is zoomed in Map Entities are resized to be larger and additionally altered to display greater detail of said Entity or Entities. As a map is zoomed out Map Entities are resized to be smaller and additionally altered to display less detail of said Entity or Entities. Entities which are configured to be visible (for example attributes, labels, Content, and Annotations) and associated with Nodes, Edges, or other Entities, are shown, hidden or resized based on user preferences and graphical readability for a particular Map display size.

The amount of screen space occupied by a Map Entity varies based on the current Zoom Factor, and is used to determine whether and to what degree various visual aspects of the Entity are rendered. If the Entity is small onscreen, illegible or unnecessary details are omitted to speed up rendering. This is particularly important when zoomed out far enough to see most or all of a large Map; in such a situation, retaining all Entity details would make it impossible to complete rendering quickly enough to keep the interface responsive to user input.

If said Entity is a Node, the four levels of detail possible, in decreasing order of screen space occupied, are:

1. Full detail: The Node Entity is rendered with its correct shape, with all of its Content, with visual effects (if applicable) such as specular highlighting and drop shadows, and with its Corona.
2. Shape only: Correct shape of the Node is rendered. Content, visual effects, and Corona associated with said Node are omitted.
3. Box only: Said Node is rendered as a rectangle. Content, visual effects, and Corona associated with said Node are omitted.
4. Invisible: Said Node is not rendered.

If said Entity is an Edge, the three levels of detail possible, in decreasing order of screen space occupied, are:

1. Full detail: The Edge is rendered with its correct head, tail, and path shape, with its Content (label), and with its Corona.
2. Shape only: The correct head, tail, and path shape of said Edge is rendered. Content and Corona of said Edge are omitted.
3. Line only: Path shape of said Edge is rendered, but head and tail shape are omitted. Content and Corona of said Edge are omitted.

Edges are always rendered. This allows the overall shape of a Map to be visualized without significant computational burden.

The memory required to represent and manage Maps scales linearly with the complexity of the Map (the number of Entities and the amount of Content). When executing on a resource-constrained device such as a smartphone, or when handling an extremely large Map, this memory footprint may cause slowdowns or instability in the operation of the Browser or other visual display.

The present invention avoids such problems by not keeping the entirety of a large Map in memory at once (where “large” is defined as “large enough to cause performance issues in the Browser or other visual display being used). Instead it maintains a cache of Map data, of size appropriate to the type of device on which the Browser or other visual display is executing. When data for a particular region of the Map is needed and not found in the cache, a “fetch” request is issued over the network to the server, which responds with the required data. The cache holds data for the following regions of the Map: A) The current Viewport (visible portion of the Map), B) A rectangular region immediately surrounding the Viewport. Though non-visible, portions of this region may become visible very shortly, as the user invokes the Pan operation; fetching data for such regions ahead of the time when it will be needed improves application performance. The size of this “prefetched” region depends on the amount of memory allocated for the cache. C) Space permitting, other regions of the Map that have been visible recently. Unused data is purged from the cache using a Least Recently Used (LRU) scheme when space is needed for newly fetched data.

FIG. 18 depicts rendering with zoom and pan. The logical Map area 1801 represents the entire Map, as stored in the local Map model 202 in FIG. 2. The user has used the panning and zooming features to display a particular portion of the Map, referred to as the viewport 1802. Following the algorithm depicted in FIG. 17, the contents of the viewport 1802 are rendered to the Browser or other visual display area 1803.

FIGS. 19 and 20 illustrate a simplified map as described above. Viewport 2001 in FIG. 20 contains Map Entities which are visually simplified. Viewport 1901 in FIG. 19 illustrates a non-simplified view of the same Map Entities.

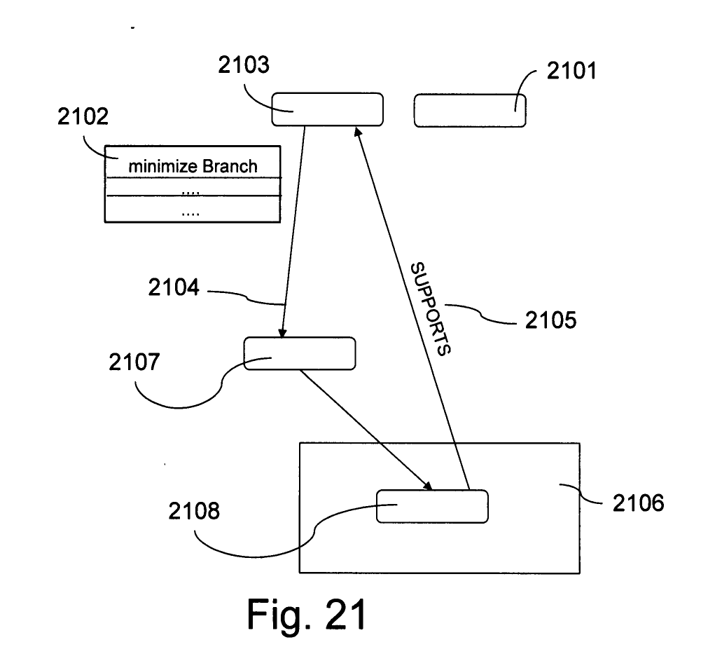

FIG. 21 illustrates typical Map Entities of one preferred embodiment of a Map. Signifier 2104 illustrates an Edge. Signifier 2105 illustrates a label associated with an Edge. Edges may or may not have associated labels Signifier 2106 illustrates a Cluster. A Cluster is a grouping of one or more Nodes or other Entities associated with a Map. Signifiers 2103, 2107, and 2108 illustrate Nodes connected by Edges. Signifier 2101 illustrates a standalone Node. Nodes may exist unconnected in this way, or have any number of connections via Edges to any Nodes without restriction.

Sequences of Nodes and Edges may form paths of any length through a Map. These paths may lead through circuitous routes to a previous node in the path. Additionally, branching at any Node in the path may occur. Such potentially complex paths, including cyclic and multiply branched paths, may be simplified and/or hidden for easier viewing of the Map. To facilitate these simplifications, all or part of a path may be minimized so that it is temporarily removed from consideration as part of the Map and visually hidden or de-emphasized. This minimization may be done by user interaction or by machine control according to user preferences. Similar simplifications are also applied when performing machine traversal including Software functions that perform calculations along paths, for example, to determine shortest path between a set of Nodes or executing a function on data associated with or contained in the Nodes and Edges along a path. Minimized Nodes may be provided with a marker or icon to indicate to the user that the Node may be expanded. Sequences of software program instructions in the present invention recognize and account for possible circular data relationships within the portion of the Map being minimized to avoid potentially harmful or wasteful recursive loops in the executing program logic which effects the minimization.

In a preferred embodiment of the present invention, when a user places a Pointing Device near or over an Edge, the Edge is highlighted indicating proximity of the Pointing Device to the Edge. The resulting highlighting indicates the availability of user operations pertaining to the Edge, which may include but are not limited to editing of the associated Edge label, deletion of the Edge, changing of the color or thickness of the Edge, reversing the Edge direction, minimizing the Branch of which the Edge is a part, etc. Signifier 2102 illustrates one preferred method of accepting user input to indicate their desire to minimize or maximize a Branch. Context menu 2102 is associated with Edge 2104. Context menu 2102 displays as a result of the user causing the Edge Corona to appear (see FIG. 29), said Corona optionally requiring additional input such as a button click to cause context menu 2102 to be displayed. The minimize and maximize method illustrated herein is only one method of achieving minimization or maximization of a Branch. Another example embodiment is the minimizing of a branch as a result of double-clicking a Node, or of selecting a function from a context menu associated with the Map in its entirety, or by accessing a visual indicium associated with an Edge or Node, or by a menu that gives a list of qualifying Nodes, Edges, or Branches, or any other method. Any method desired may be used to initiate the minimization or maximization of a Branch or Branches without departing from the scope of the present invention.

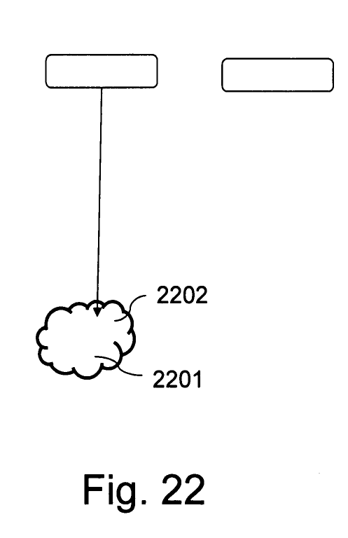

FIG. 22 illustrates a display of a Map after minimizing a Branch by actuating indicium 2102 in FIG. 21, resulting in a less complex Map. Circular relationships are automatically detected during the minimize/maximize process so that infinite loops do not result during the Software execution of the minimize or maximize function. Also, minimized Branches may optionally be excluded from automated calculations which might be performed on Entities of the Map such as Map analysis or the execution of special software associated with specific Nodes or Edges. Signifier 2201 indicates the position of the minimized Branch. Minimization in the present example is represented by completely hiding the Entities of said Branch and replacing it with indicium 2201. Other representations of minimization are possible without departing from the scope of the present invention. The minimization proceeds by following the path of directional Edges. A directional Edge may be conceptualized for purposes of explanation as an Edge proceeding from an “origin” Map Entity (such as a Node) to a “target” Map Entity (such as another Node). All Map Entities connected to an Edge in said path which are not also target Entities of another un-minimized path, are minimized. Note that Cluster 2106 (see FIG. 21) was also minimized. In the present example, Clusters which contain only minimized Map Entities are themselves minimized, but this is optional behavior, and other behaviors of Clusters which are associated with a Branch being minimized are possible without departing from the scope of the present invention.

In another preferred method of accepting user input to indicate the desire to maximize a Branch, indicium 2202 makes available to the user the function of maximizing the minimized Branch. Other indicia for representing the function of maximization or minimization are possible without departing from the scope of the present invention.

In the present invention, machine-executable program logic for display-only of a Map or Maps may be embedded in web pages viewable without the need to download or have access to the Map Client. The user or users with editable access to a map may define “snapshots” of a Map which become available for embedding in web pages. Thus, at various points during the creation of a map, the map may be “published” by creating a “snapshot”. The snapshot defined as active will be viewable in all web pages in which it is embedded.

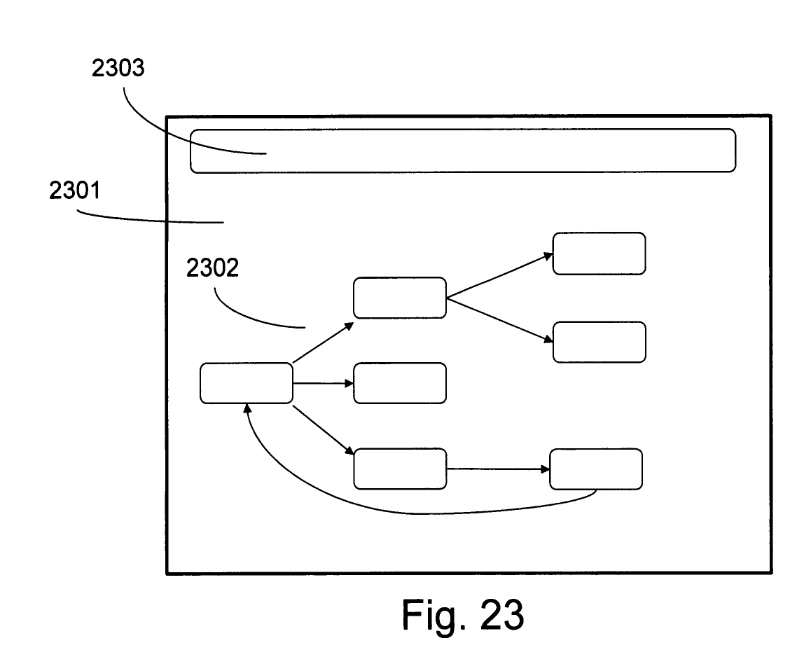

FIG. 23 illustrates the embedding of a Map 2302 within website 2301 said website content illustrated by example 2303. A subset of the Map Client architecture as illustrated in FIG. 2 is used to display Map 2302 with similar characteristics to a Map displayed using the full Map Client architecture, but with the ability to restrict certain features if desired. What features are restricted and what subset of functionality is made available to the user is variable within the scope of the present invention and depends on the application desired.

Depending on the current Zoom Factor, the screen space available to render a Node's Content may be insufficient; in this case the excess Content is hidden. To allow users to inspect a Node's Content without having to zoom in (and later zoom out to resume browsing the Map at the same level), Nodes may be maximized—the user invokes the feature using a Pointing Device, keyboard, or other input device and in response the Node is enlarged on a display device. User input directed away from the enlarged Node causes the Node to be redrawn at normal size.

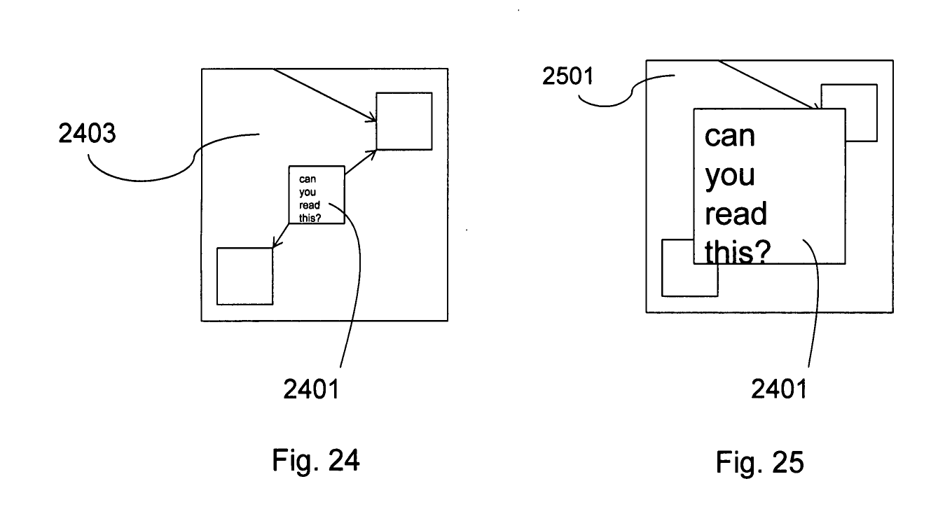

FIGS. 24 and 25 depict the maximization feature of Nodes, which allows the user to expand a Node to fill the screen, so as to more easily read and inspect its contents. In view 2403, a portion of a Map is shown, with the Node to be maximized 2401. In view 2501 of FIG. 25, the user has invoked the Node maximization feature (in one embodiment of the present invention, by double-clicking the Node using a Pointing Device), causing the Node 2401 to be expanded and, optionally, the rest of the Map to be faded.

Entities of a Map may optionally be surrounded by spatial regions referred to herein as Coronas. Said Coronas respond to the proximity of a Pointing Device in ways definable by program logic. In one preferred embodiment, when a user moves a Pointing Device near a Node in the user interface, a new, unconnected Edge automatically appears at the current Pointing Device position that the user can then attach to the nearby Node by Dragging the Edge to attach the open end to another Node or any other object which is enabled for connection to an Edge.

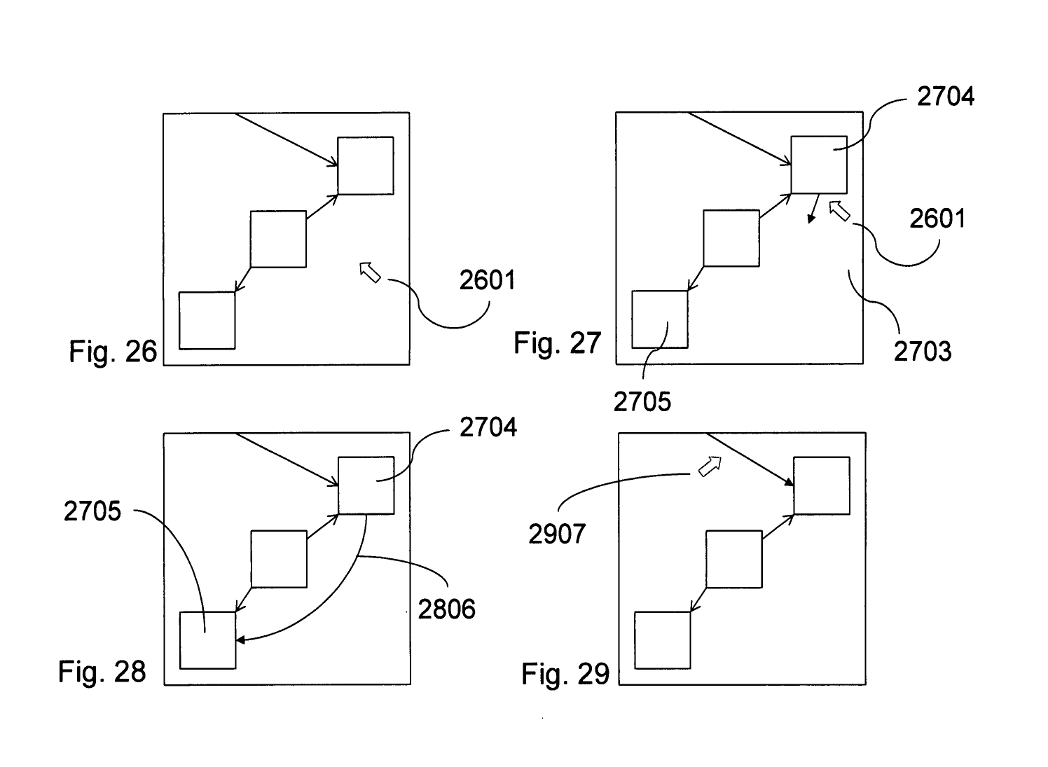

FIGS. 26 through 29 inclusive depict the corona feature of Nodes and Edges, which allows a preset behavior to be triggered when Pointing Device is moved near an Entity in the Map. In FIG. 26, a portion of a Map is shown, with Pointing Device indicator 2601 over neither Entity. In FIG. 27, the Pointing Device indicator 2601 is moved over the corona of a first Node 2704; in a preferred embodiment of the present invention, the triggered behavior is to display a new suggested Edge 2703, which the user can “grab” (by any action defined; in one example the grabbing action may be effected by holding down the primary Pointing Device button) and then Dragging to a second Node 2705, which causes the generation of an Edge 2806, depicted in FIG. 28, which connects said first Node 2704 with said second Node 2705. In FIG. 29, the Pointing Device indicator 2907 is moved within the corona of an Edge; in the preferred embodiment, the behavior triggered is to change the color of the Edge corona, making the Edge appear highlighted and expanding the selectable area of the Edge, for subsequent access to whatever actions are provided for selected Edges.

Activation of an Edge using a click or a gesture triggers a program logic-controlled automatic Edge navigation function. Such function automatically navigates the Map to center a target Node on the user display. The target Node is the Node at the connected end of the specified Edge. While the navigation is under way, the Map may optionally zoom out to larger viewable context and then zoom back in when it arrives at the target. The speed of this automatic navigation is optionally moderated to optimize user experience.

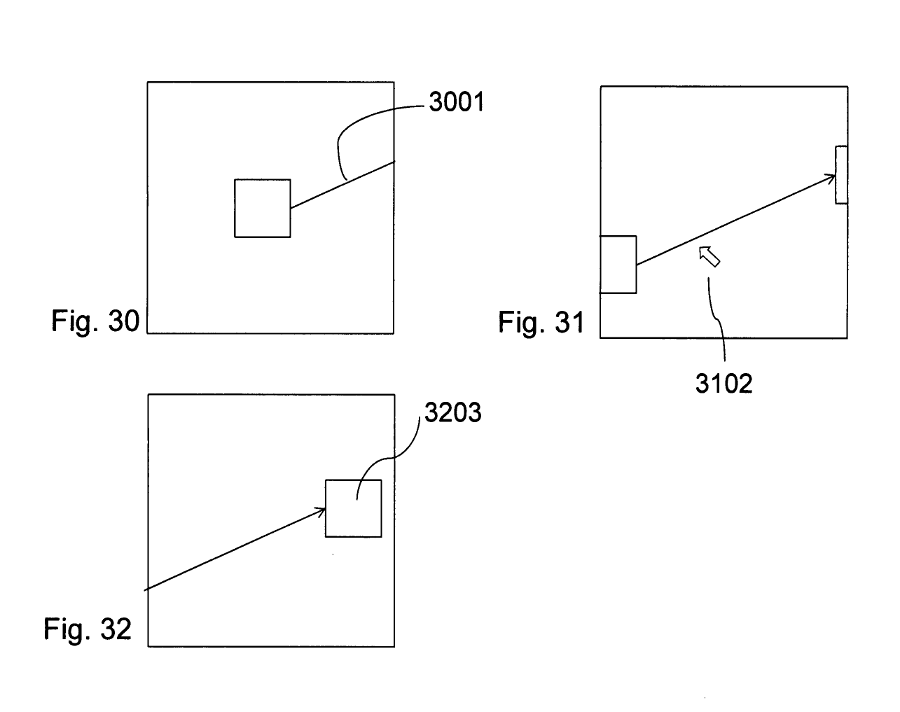

FIGS. 30 through 32 inclusive depict the Edge Navigation feature of Edges, which, for an Edge with only one currently visible endpoint Node, allows the user to discover the opposite endpoint. In FIG. 30, a Node and its incident Edge 3001 leading out of the viewport are shown. In FIG. 31, the user has invoked the Edge navigation feature (in a preferred embodiment, by double-clicking on the Edge, its corona, or its label using a Pointing Device indicium 3102), causing the Map to begin panning automatically in the direction of the Edge. In FIG. 32, the panning terminates as the opposite endpoint of the Edge, Node 3203, has been brought into the viewport.

Edges can have associated descriptive text, labels or other Content. Said Content is automatically aligned with the Edge so that it follows the Edge along its path at any angle or curvature, making said Content much more legible when multiple Edges appear in proximity. In addition, said Content may be automatically reoriented for best readability including elimination of upside-down Content.

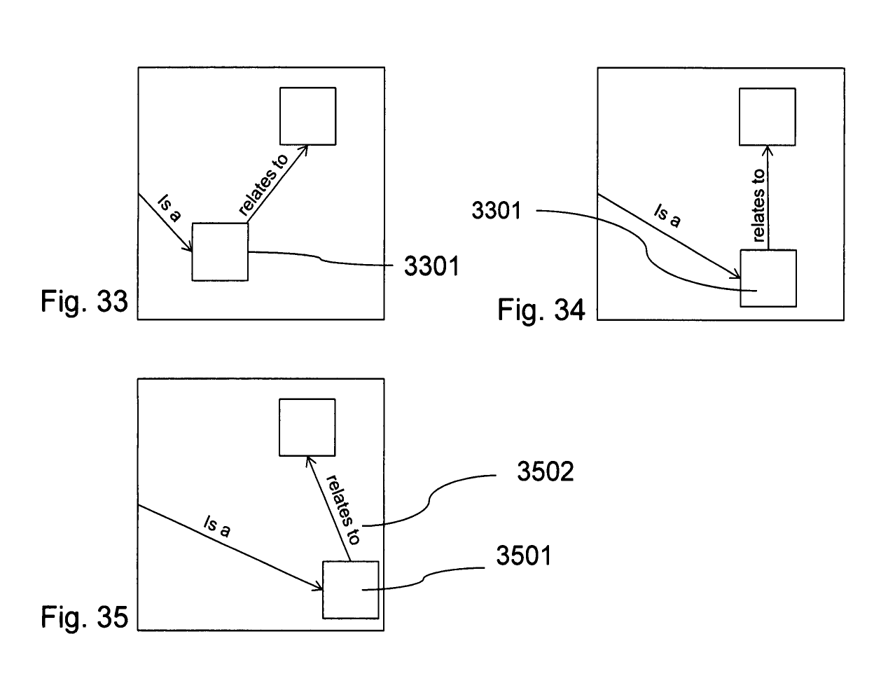

FIGS. 33 through 35 inclusive depict the Edge label fitting feature, in which Edge labels are shaped to fit the path of their Edges at all times, and are always oriented so as to be readable by the user. In FIG. 33, a Node 3301 and two of its Edges are shown. In FIG. 34, the user has begun Dragging Node 3301, causing its Edges to be Dragged with it, and causing the Edge labels to adjust their paths accordingly. In FIG. 35, Node 3501 has been Dragged so far that one of the Edge labels 3502 would be rendered upside down, were it not for Edge label fitting; instead, the orientation of the label is flipped and the label remains upright and readable.

The present invention provides for the detachment of one end of an Edge from a connected first Node and re-attachment of said end to a second Node while retaining all desired aspects of the Edge, for example color, thickness, arrowhead type, label, and any other aspect of said Edge. Either end of an Edge may be reconfigured to connect to a different Node without the need to delete or otherwise alter the properties of Nodes or the Edge. This obviates the need, common in the related art, to execute several steps in order to move the endpoint(s) of an Edge, for example, deleting an Edge connected to a first Node and creating a new Edge for connection to a second Node, thus requiring at least two steps to achieve the reconfiguring of the endpoints of an Edge. In addition, if a deletion of said Edge is required to achieve the desired Edge relocation, possibly more than two steps are necessary if an Edge label, Edge color, or other attribute of the deleted Edge must be re-defined for the newly created Edge. The present invention avoids these time-consuming and error-prone steps.

In one preferred embodiment, when a user moves a Pointing Device near an Edge in the user interface, a visual indicator, typically a cursor, appears. This visual indicator may optionally indicate which end of the Edge is closest in proximity to the Pointing Device, which is useful, for example, to indicate that the end of the Edge indicated is available for relocation to a different target Entities such as a different Node, as described in claim 39.

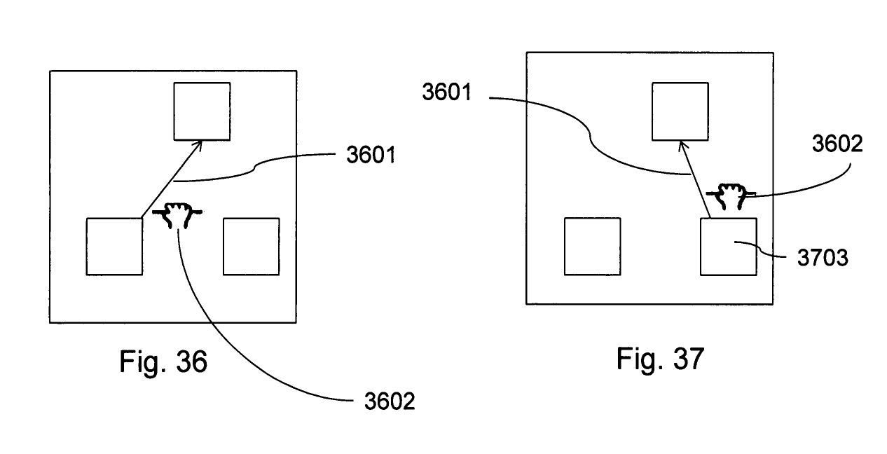

FIGS. 36 and 37 illustrate repositioning the tail end of an Edge. In FIG. 36, a Pointing Device has approached the tail end of Edge 3601, which causes the normal indicium of the Pointing Device to change to indicium 3602, in this example a hand holding a line. Any other indicium 3602 could be used without departing from the scope of the present invention. The tail end of Edge 3601 may then be “grabbed”. In one preferred embodiment, said “grabbing” is done by Dragging with the Pointing Device. In FIG. 37 the tail end of Edge 3601 has been “dropped”—typically by releasing the Pointing Device button—onto Node 3703, which causes the tail end of Edge 3601 to attach to Node 3703.

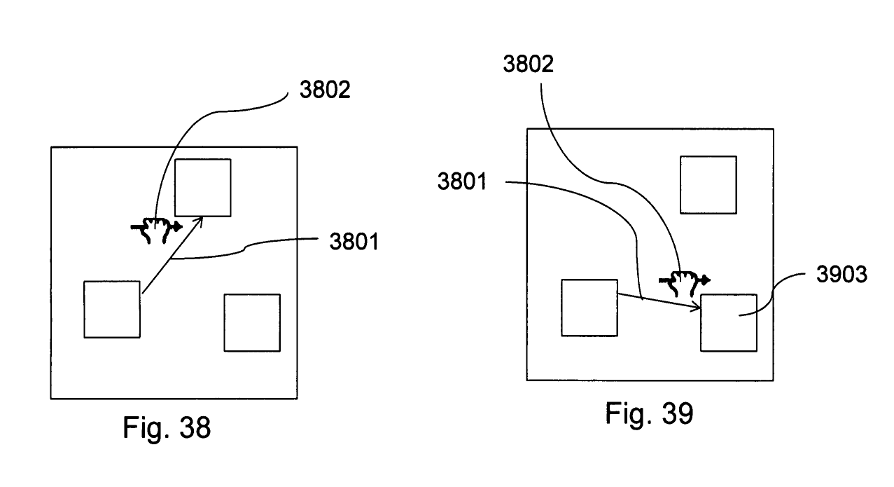

FIGS. 38 and 39 illustrate repositioning the head end of an Edge. In FIG. 38, a Pointing Device has approached the head end of Edge 3801, which causes the indicium of the Pointing Device to change to indicium 3802, in this example a hand holding an arrow. Note that this indicium differs from indicium 3602 in FIG. 36, to indicate proximity to the head end of the Edge rather than to the tail end of said Edge. Any other indicium 3802 could be used without departing from the scope of the present invention. The head end of Edge 3801 may then be “grabbed”. In one preferred embodiment, said “grabbing” is done by Dragging with the Pointing Device. In FIG. 39 the head end of Edge 3801 has been “dropped”—typically by releasing the Pointing Device button—onto Node 3903, which causes the head end of Edge 3801 to attach to Node 3903.

Each Cluster data object has all of the properties of an ordinary Node, as well as a list of “children” (Nodes contained within said Cluster), if any. The CSS z-index of Clusters is set to a level lower than that of non-Cluster Nodes, so that Nodes will appear in front of Clusters when rendered, allowing for the visual effect of containment of a Node by a Cluster. Further, the representation of Nodes is extended with the following property: identifier of “parent” (containing cluster), if any. The CSS z-index of Clusters is set to a level lower than that of non-Cluster Nodes, so that Nodes will appear in front of Clusters when rendered, allowing for the visual effect of containment of a Node by a Cluster. A Cluster may optionally be given a designation to denote some arbitrary similarity between the one or more Map Entities or other Clusters within said Cluster.

One or more Nodes or other Map Entity may be added or removed from a Cluster by dragging said Nodes or said Map Entities into or out of a Cluster using whatever user interface facility is provided, for example by Pointing Device movement.

Since all non-Cluster Nodes are visually depicted in front of all Clusters, a Node that is not a member of a Cluster, but which overlaps the Cluster in logical space and on the screen, will misleadingly appear to be contained within the Cluster. To avoid this, upon rendering a Node, such overlaps are rapidly detected using the Entity Locator. If an overlap exists, the border region of the Node (which is the Corona if such is enabled, see “Coronas”) has its color set to one that contrasts with the background color of the Cluster.

The present invention enables Clusters to be minimized or hidden, with the added feature that the Map Entities or Content contained within minimized Clusters are also minimized or hidden when the containing Cluster is minimized or hidden, and said Map Entities and said Content are restored to visibility when the minimisation or hiddenness of the containing Cluster is reversed.

The present invention enables Clusters to contain any number of Map Entities or other Clusters without limit.

The present invention enables one or more Edges to be represented in Memory and optionally made visible on a display device as connecting Entities between Clusters. There is optionally also be a visual indicator to display that one or the other endpoint of said Edge is a Cluster. An Edge connected to a cluster may be repositioned, deleted, added, or otherwise manipulated in the same way that an Edge is to any Node.

The present invention enables Clusters to contain Content which may be hidden or displayed, deleted or manipulated by a user or by automated program logic.

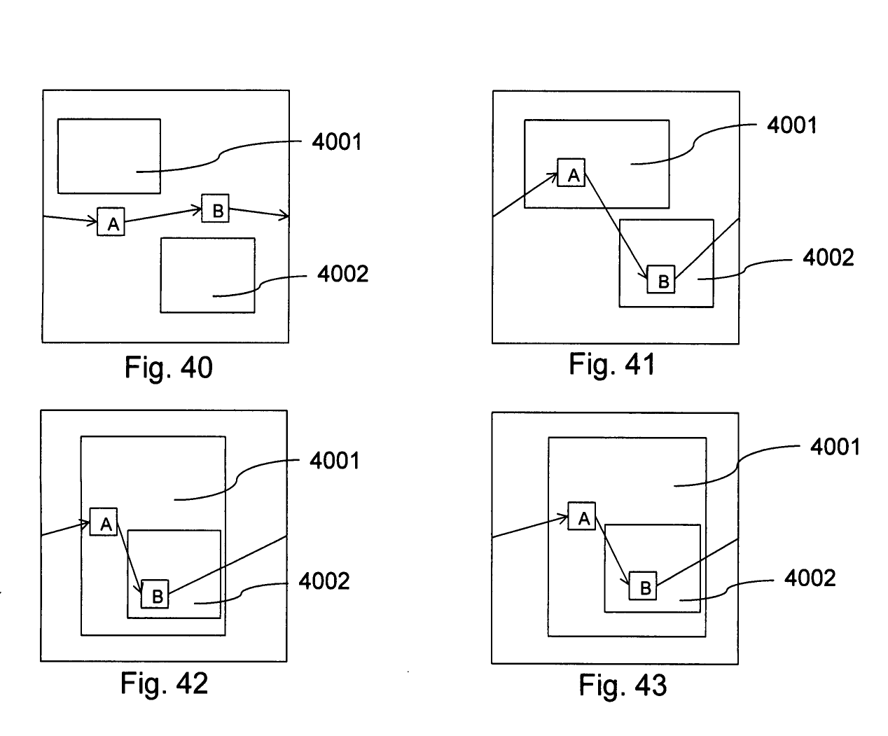

FIGS. 40 through 43 inclusive depict the clustering feature, in which Clusters can contain regular Nodes, other Clusters, or other Map Entities. In FIG. 40, two Clusters, several Nodes, and their incident Edges are shown. In FIG. 41, Node A has been moved into Cluster 4001 and Node B has been moved into Cluster 4002 (in one embodiment, said movements are performed by pressing and holding the primary Pointing Device button while the Pointing Device's position indicator or cursor is over the Node, Dragging the Node until the Pointing Device position indicator is over the Cluster, and releasing the Pointing Device button). The Clusters are automatically resized to fit the Nodes they contain. In FIG. 42, Cluster 4002 is Dragged into Cluster 4001; again, the outer Cluster is automatically resized. In FIG. 43, Cluster 4001, the outermost containing Cluster, is Dragged, which causes all of the Nodes and Clusters it contains, both directly and indirectly, to be moved as well.

If two or more users make conflicting changes to a Map, they are applied in the order in which they are received at the Map Server. If a change would introduce inconsistency or Map corruption, given that a previous change has been applied, the later change is rejected and the user of the originating Map Client is visually notified.

When a user makes a change to a Map, the inverse of that change is added to a list called herein the Undo List. This allows any change to the Map to be rolled back at the user's request. Undo Lists are not transmitted to the Map Server, thus allowing users to undo their own changes but not those of their collaborators. For the purposes of collaboration, requests to undo a change are treated like any other change: they are processed in the order they are received at the Map Server and rejected if they would introduce inconsistency or corruption to the current Map. Every modification operation on the Map is implemented so as to generate its own inverse, an “Undo Operation” that will restore the Map to its state prior to the modification in question. These are stored on a stack (a “last in, first out” data structure). Most attempts to modify the Map, either by the user or by the system, will require several such operations in sequence and thus generate several Undo Operations. If the modification attempt is cancelled while in progress, the operations on the Undo Operation stack are “popped” and executed (in a natural reverse order). If the modification attempt is completed successfully, the stack is given to the user interface controller as a single “Undo Transaction”, and a new empty stack is created to replace it.

The controller keeps two stacks of its own: an Undo Transaction stack and a Redo Transaction stack. When a normal modification to the Map completes successfully, the controller receives an Undo Transaction, which it “pushes” onto the Undo Transaction Stack. It then clears the Redo Transaction stack. The Undo and Redo features are temporarily disabled if the Undo or Redo Transaction stacks, respectively, are empty.

If the user invokes the Undo feature, the most recent transaction pushed onto the Undo Transaction Stack is popped and executed, restoring the Map to its prior state. Since the Undo Transaction is processed just like any other modification attempt, its inverse is generated; this transaction would reproduce the change just undone, and is therefore pushed onto the Redo Transaction stack.

If the user invokes the Redo feature, the most recent transaction pushed onto the Redo Transaction stack is popped and executed, reapplying the last non-Undo modification performed on the Map. Its inverse is generated and pushed onto the Undo Transaction stack. Critically, neither Undo nor Redo are treated unusually by the server, which sees them as ordinary modifications to the Map; it has no knowledge that a modification was invoked via Undo or Redo as opposed to via normal user input or automatic triggers. Thus, invocation of Undo or Redo does not require any notification to other users accessing a shared Map, nor does it require synchronization of Undo/Redo stacks. This avoids the many complicated synchronization issues that plague most collaborative real-time document editing systems, including those that handle concept maps.

If an intervening change to a shared Map by a first user makes an Undo or Redo transaction invoked by a second user invalid, the Undo or Redo transaction is cancelled, and the second user notified, in the same manner as for any normal conflict. This does, at times, prevent the second user from undoing a change when he or she desires to do so. However, allowing such an Undo to execute would also have the effect of undoing (and perhaps only partially) a change made by the first user, in a manner that would be confusing, possibly jarring, and potentially harmful to the data integrity of the Map. As mentioned earlier, such problems are commonplace in modem collaborative real-time document editing systems. Notifying the second user of the conflict is a cleaner, safer, and more comprehensible solution; users are now empowered to make fully-informed and project-specific decisions on how to resolve the conflict.

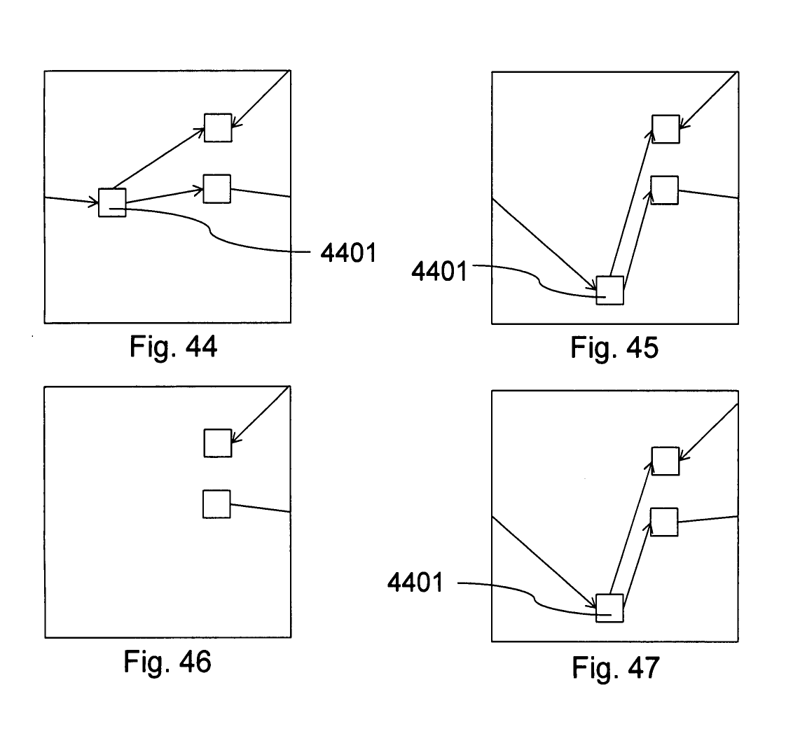

FIGS. 44 through 47 inclusive depict the undo and redo features, in which changes made to the Map can be cancelled (in reverse chronological order), and cancelled changes can be reapplied to the Map (again, in reverse chronological order). In FIG. 44, a portion of a Map is shown, including Node 4401. In FIG. 45, Node 4401 is moved. In FIG. 46, Node 4401 is deleted, which in turn causes its incident edges to be deleted as well. In FIG. 47, the user invokes undo, causing the deleted Node 4401 to reappear, along with all of its incident edges.

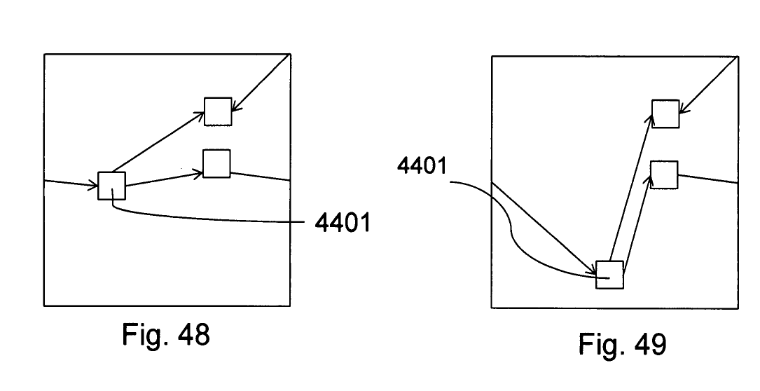

FIGS. 48 and 49 depict a continuation of the undo and redo example depicted in FIGS. 44 through 47 inclusive. In FIG. 48, the user invokes undo a second time, causing Node 4401 to move back to its original position as illustrated in FIG. 44. In FIG. 49, the user invokes redo, causing Node 4401 to move again in the same manner as in FIG. 47.

Nodes or other Entities in a single Map or a plurality of Maps may be visibly differentiated and may be denoted in Memory as being one of a collection of the most-recently changed Entities in the Map or Maps. For example, given a collection of most-recently changed Nodes, the differentiation may be, for example, by Node coloring, Node border, or other Node aspect. What Entity characteristic is chosen to differentiate recently-changed Entities may vary depending on the type of Entity or Entities, for example Nodes, Edges, Annotations, Clusters, etc. Inclusion into a set of most-recently changed Entities of a certain type, for example most-recently changed Nodes, may be determined by the existence of changes or additions that have occurred within a given time period, or by detection of the most recent N changes or additions to occur where N is any number chosen by configuration or by automated program logic.

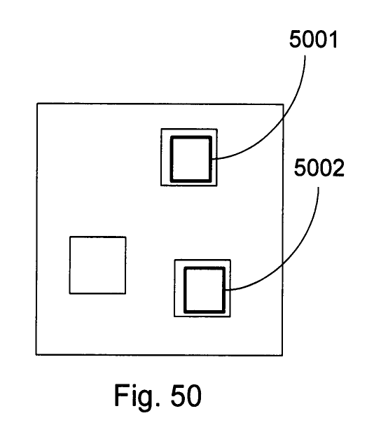

FIG. 50 depicts Map Entities that are visually set apart due to their status as most-recently changed. Indicia 5001 and 5002 are borders of a color contrasting with the color of their respective Nodes. Any indicia or other method of differentiation may be chosen without departing from the scope of the present invention.

The present invention optionally includes program logic embodying an Application Programming Interface (API) allowing a subset or the entirety of the features and functionality described herein to be executed. Said API may be accessed by any remote or local program logic, including but not limited to the widespread methods of representational state transfer (REST), simple object access protocol (SOAP), and remote procedure call (RPC).

### 3. How to Use the Invention

The problems addressed by the present invention are many as can be readily seen by those skilled in the art. The present invention improves upon the prior art by increasing the size of Maps which may be manipulated interactively and simultaneously by large numbers of users while also allowing the Maps to be viewed in part or in their entirety as desired by each individual user, without need for transport of files or labor-intensive configuration and setup. In addition, the present invention makes feasible and readily accessible the interactive manipulation of large Maps by many simultaneous users when the Maps include a large amount of multimedia Content. The present invention expands the types of Content which may be displayed directly in a Map. The present invention adds numerous user interface enhancements which make interaction with Maps for purposes of editing easier and more flexible. The present invention interfaces with existing Software systems which perform document repository, social collaboration, and data mining services, extending them to reveal new patterns of information and make navigation of the output of said Software systems easier and more intuitive. The present invention has application and utility in any application where real time collaboration is desired along with the ability to constrain or validate user or program actions based on a permissions policy and/or business logic, along with the optional capability of undo and redo of user or programmatic actions. Examples of such applications are collaborative gaming, document editing, collaborative brainstorming, data mining, process control and monitoring, and collaborative systems where user input is used to alter the flow or outcome of data being broadcast to a plurality of users, for example in interactive entertainment, real-time opinion polling or interactive, collaborative composition of music, text, visual art, or other creative forms.

While the present invention has been disclosed in its preferred embodiments, it is to be understood that the invention is not limited to the precise disclosure contained herein, but may otherwise be embodied with various changes, modifications and improvements which may occur to those skilled in the art, without departing from the scope of the invention as defined in the appended claims.

What is claimed is:

1. An apparatus comprising: a computer software product that includes a medium readable by a processor, the medium having stored thereon a set of instructions operable to store, process, retrieve, display, modify, and interpret one or more maps; a sequence of instructions operable to represent zero or more nodes, each as an identifier and optionally as content, as containing content, or as associated with content; a sequence of instructions operable to represent zero or more edges, each as an identifier and optionally as content, as containing content, or as associated with content; a sequence of instructions operable to add or to remove one or more new nodes to a map; a sequence of instructions operable to modify the properties or content of one or more nodes; and a sequence of instructions operable to add or to remove one or more new edges to a map.

2. The computer system apparatus according to claim 1, wherein said computer program logic is embodied in whole or in part on each of a plurality of computer systems coupled together by a network or telecommunications link.

3. The computer system apparatus according to claim 1, wherein said computer program logic is embodied on a single computer system.

4. The computer system apparatus according to claim 1 wherein exists a sequence of instructions operable to present one or more maps visually in or on a user interface to an individual user.

5. The computer system apparatus according to claim 1 wherein exists a sequence of instructions operable to present one or more maps visually in or on user interfaces to a plurality of physically separated users.

6. The computer software product according to claim 1 further comprising a sequence of instructions operable to accomplish efficient visual presentation of one or more maps in their entirety or in any portion thereof, regardless of the number of nodes and edges or amount of content in said maps, and regardless of the execution speed and storage limitations of the device or devices through which said maps are to be displayed.

7. The computer software product according to claim 1 further comprising a sequence of instructions operable to accomplish efficient visual presentation of one or more maps by use of a space partitioning tree data structure to perform rapid retrieval from storage of portions or the entirety of said maps.

8. The computer software product according to claim 1 further comprising a sequence of instructions operable to accomplish efficient visual presentation of one or more maps by use of a dual-buffer drawing system, wherein the portion of a map to be displayed is first drawn to a non-visible storage area and the resulting image is then transferred to the visible display.

9. The computer software product according to claim 1 further comprising a sequence of instructions operable to accomplish efficient visual presentation of one or more maps by use of a rapid-access temporary data store to hold only the portion of the map currently displayed, or a portion of the map larger than that currently displayed, said temporary data store being refilled with map data as needed.

10. The computer software product according to claim 1 further comprising a sequence of instructions operable to accomplish efficient visual presentation of one or more maps by selecting and omitting from the drawing process some or all visual or functional details that would be too small to be clearly visible to a user.

11. The computer software product according to claim 1 further comprising: a sequence of instructions operable to represent one or more maps shared among one or more users, each potentially using a separate computer or terminal, as instances or representations of map data for each user; a sequence of instructions operable to synchronize each user's map instance or representation of map data in a timely fashion following any modification of the map; a sequence of instructions operable to effect selective cancellation or adjustment of said modifications to resolve any logical conflicts arising from said modifications.

12. The computer software product according to claim 1 further comprising: a sequence of instructions operable to represent modifications made to a map by a particular user in a chronologically ordered list; a sequence of instructions operable to manipulate a shared map, comprising reversal or reapplication of previously performed modifications, wherein such reversals and reapplication are processed in the same manner as ordinary modifications and do not interfere with the synchronization or consistent presentation of the map with respect to one or more users, each potentially using a separate computer or terminal.

13. The computer software product according to claim 1 further comprising: a sequence of instructions operable to represent a map or portion of a map as zero or more clusters, in addition to any other entities represented in said map; a sequence of instructions operable to manipulate one or more clusters in a graphical user interface by dragging one or more nodes or other map entities, including association of one or more nodes or other map entities with a cluster and removal of one or more nodes or other map entities from association with a cluster.

14. The computer software product according to claim 1 further comprising: a sequence of instructions operable to represent a map or a portion of a map as zero or more clusters, in addition to any other entities represented in said map; a sequence of instructions operable to present a map graphically in a manner such that one or more clusters may be displayed in a simplified form that does not include or renders invisible the nodes, other map entities, or content associated with said clusters; optionally, said simplified form including one or more indicia of the existence of said simplified cluster or clusters; a sequence of instructions operable to mark one or more clusters in a manner that indicates the availability of instructions operable to cause said clusters to be displayed in normal or in simplified form.

15. The computer software product according to claim 1 further comprising a sequence of instructions operable to present a map graphically in a manner such that one or more nodes are displayed in an enlarged form for the purpose of enhancing the visibility of said nodes, for increasing the legibility of the content associated with said nodes, or for another purpose.

16. The computer software product according to claim 1 further comprising a sequence of instructions operable to navigate a map by movement of the visible portion of said map along the path of an edge.

17. The computer software product according to claim 1 further comprising a sequence of instructions operable to manipulate an edge in a map whereby one or both endpoints of said edge may be independently reassigned to different entities or locations within said map.

18. The computer software product according to claim 1 further comprising a sequence of instructions operable to present a map graphically in a manner such that content associated with each edge is displayed near the edge, in a shape similar to the shape of the edge itself, and wherein any movement or change in the shape of the edge causes a corresponding movement or change in the shape of the displayed content.

19. The computer software product according to claim 1 further comprising a sequence of instructions operable to present a map graphically in a manner such that the shape or form of a pointing indicator is modified when in proximity to either of the two endpoints of an edge, optionally indicating which of the two endpoints is closest to the pointing indicator.

20. The computer software product according to claim 1 further comprising: a sequence of instructions operable to present a map graphically in a manner such that the screen space occupied by one or more map entities is surrounded by a corona; a sequence of instructions operable to initiate further action with respect to the entity enclosed in a corona, upon user input directed towards said corona in the form of movement or other action of a pointing device; optionally, a sequence of instructions operable to present a map graphically in a manner such that user input directed towards a corona, in the form of movement or other action of a pointing device, causes the entity enclosed in said corona or said corona itself to be visually highlighted or made visible.

21. The computer software product according to claim 1 further comprising: a sequence of instructions operable to present a map graphically in a manner such that the screen space occupied by one or more nodes is surrounded by a corona; a sequence of instructions operable to present a map graphically in a manner such that user input directed towards a corona, in the form of movement or other action of a pointing device, causes a new temporary edge to be displayed originating at said node or nodes; a sequence of instructions operable to add one or more permanent or semi-permanent edges to a map, by dragging one or more said temporary edges from a corona surrounding one or more nodes to a destination endpoint.

22. The computer software product according to claim 1 further comprising: a sequence of instructions operable to present a map graphically in a manner such that the screen space occupied by one or more edges is surrounded by a corona; a sequence of instructions operable to present a map graphically in a manner such that user input directed towards said corona, in the form of movement or other action of a pointing device, causes the edge enclosed in said corona, or said corona itself, to be visually highlighted or made visible; a sequence of instructions operable to manipulate a map, including but not limited to modification of the properties and/or content of said edge, which are made available for selection and execution upon user input in the form of movement or other action of a pointing device directed towards the corona surrounding said edge.

23. The computer software product according to claim 1 further comprising: a sequence of instructions operable to present a map graphically in a manner such that selected portions of said map are presented in a simplified form that do not display the individual entities contained in said portions; a sequence of instructions operable to analyze a map, including delineation of one or more portions of said map for simplified presentation; a sequence of instructions operable to change the presentation of a portion of a map into simplified or non-simplified form.

24. The computer software product according to claim 1 further comprising: a sequence of instructions operable to present a map graphically in a manner such that said map is automatically presented in a simplified form that does not display certain details of the individual entities contained in said map when the visual display size of said entities is smaller than some threshold size.

25. The computer software product according to claim 1 further comprising: a sequence of instructions operable to graphically present a reproduction map within a web page, wherein the nodes, edges, content, and other entities in said reproduction map are identical to the corresponding entities in a designated original map at a designated point in time; sequences of instructions to manipulate said reproduction map independently of said original map; sequences of instructions to manipulate said original map independently of said reproduction map.

26. The computer software product according to claim 1 further comprising: an application programming interface consisting of a sequence of instructions operable to receive and interpret requests to create, modify, or delete one or more maps via internal computer program logic or via one or more telecommunications networks.

27. The computer software product according to claim 1 further comprising: a sequence of instructions operable to visibly or otherwise differentiate an entity which is a member of a collection of the most-recently changed entities in one or more maps.

28. A method for storing information related to maps comprising the steps: of adding one or more nodes; removing one or more nodes; organizing one or more nodes; modifying one or more nodes; adding one or more edges; removing one or more edges; organizing one or more edges; modifying one or more edges; presenting one or more maps to an individual user or jointly to a plurality of physically separated users; wherein said one or more maps are presented in their entirety or in any portion thereof independently of the number of nodes and edges or amount of content in said maps and independently of the execution speed and storage limitations of the device or devices through which said maps are displayed; and upon receipt of one or more requests.

29. The method of claim 28, wherein one or more maps are displayed by use of a space partitioning tree data structure to perform rapid retrieval from storage of portions or the entirety of said maps.

30. The method of claim 28, wherein efficient visual presentation of one or more maps is accomplished by use of a dual-buffer drawing system, wherein the portion of a map to be displayed is first drawn to a non-visible storage area and the resulting image is then transferred to the visible display.

31. The method of claim 28, wherein efficient visual presentation of one or more maps is accomplished by use of a rapid-access temporary data store to hold only the portion of the map currently displayed, or a portion of the map larger than that currently displayed, said temporary data store being refilled with map data as needed.

32. The method of claim 28, wherein efficient visual presentation of one or more maps is accomplished by selecting and omitting from the drawing process some or all visual or functional details that would be too small to be clearly visible to a user.

33. The method of claim 28, wherein each user's map instance or representation of map data is synchronized in a timely fashion following any modification of the map and selective cancellation or adjustment of said modifications are resolved of any logical conflicts arising from said modifications.

34. The method of claim 28, wherein modifications made to a map by a particular user are represented in a chronologically ordered list, and previously performed modifications to a map may be reversed, wherein such reversals and reapplications are processed in the same manner as ordinary modifications and do not interfere with the synchronization or consistent presentation of the map with respect to one or more users, each potentially using a separate computer or terminal.

35. The method of claim 28, wherein a map includes zero or more clusters which are modified by utilizing a graphical user interface to drag one or more nodes or other map entities into or out of said cluster or clusters in order to associate or disassociate said entities with said cluster or clusters.

36. The method of claim 28, wherein one or more clusters in a map are displayed in a manner such that said clusters are displayed in a highly simplified form the nodes, content, or other map entities associated with said clusters are rendered invisible or in otherwise altered form and said clusters optionally replaced by one or more indicia of the existence of said clusters; wherein said clusters may be restored to normal visibility, replacing said simplified form.

37. The method of claim 28, wherein one or more nodes are displayed in an enlarged form for the purpose of enhancing the visibility of said nodes, for increasing the legibility of the content associated with said nodes, or for activating functions associated with said nodes, or for another purpose.

38. The method of claim 28, wherein the visible portion of a map is automatically moved along the path of an edge.

39. The method of claim 28, wherein one or both endpoints of an edge associated with one or more map entities may be independently reassigned to different entities or locations within said map.

40. The method of claim 28, wherein a map is presented graphically in a manner such that the shape or form of a pointing indicator is modified by the step of moving the pointing indicator to be in proximity to either of the two endpoints of an edge, indicating which of the two endpoints is closest to the pointing indicator.

41. The method of claim 28, wherein a map is presented graphically in a manner such that the screen space occupied by some or all map entities is surrounded by a corona; wherein optional further action with respect to the entity enclosed in a corona is initiated by a sequence of instructions as a result of the step of user input being directed towards said corona in the form of movement or other action of a pointing device.

42. The method of claim 41, wherein the step of user input being directed towards the corona associated with a node causes a new temporary edge to be displayed originating at said node, and said temporary edge causes the addition of one or more permanent or semi-permanent edges to a map by the step of a user dragging said temporary edge from said corona surrounding said node to a destination endpoint.

43. The method of claim 41, wherein the step of user input being directed towards the corona associated with a node causes the edge enclosed in said corona to be visually highlighted or made visible to indicate the availability of a sequence of instructions operable to perform operations associated with said edge.

44. The method of claim 28, wherein a map is presented graphically in a manner such that by the step of a user activating an indicium or by automated request, selected portions of said map are presented in a simplified form that renders invisible the individual entities contained in said portions; including the step of automated analysis of said map by an operable sequence of instructions to ensure proper delineation of one or more portions of said map for simplified presentation.

45. The method of claim 44 wherein said map is converted into non-simplified form.

46. The method of claim 28, wherein the step of zooming out a map beyond a given threshold of visual display size results in said map being automatically presented in a simplified form that does not display certain details of the individual entities contained in said map.

47. The method of claim 28, wherein upon the step of a user viewing a designated web page, a reproduction of a map within said web page is displayed, wherein the entities in said reproduction map are identical to the corresponding entities in a designated original map at a designated point in time.

48. The method of claim 28, wherein the step of issuing specified software instructions, via internal computer program logic or via one or more telecommunications networks, adhering to an application programming interface associated with the present invention permits access to the functions of creating, modifying, or deleting one or more maps.

49. The method of claim 28, wherein upon the step of a user viewing a designated map, map entities of said map are displayed in a manner which visibly or otherwise differentiates said map entities which are members of a collection of the most-recently changed map entities in one or more maps.
